(19) United States
(12) Patent Application Publication
(10) Pub. No.: US 2026/0145416 A1
(43) Pub. Date: May 28, 2026

(54) EDGE CLIPPING PROTECTION

(71) Applicant: Valaurum, Inc., Portland, OR (US)

(72) Inventor: Adam Trexler, Portland, OR (US)

(21) Appl. No.: 18/958,828

(22) Filed: Nov. 25, 2024

(51) Int. Cl. B32B 38/00; B32B 15/09; B32B 37/24; B32B 38/18

(52) U.S. Cl. CPC B32B 38/0004; B32B 15/09; B32B 37/24; B32B 38/145; B32B 38/185; B32B 2037/243; B32B 2307/4023; B32B 2307/412; B32B 2311/04

(57) ABSTRACT

A method may include applying a base layer on a first transparent substrate may include a first pattern. At least a portion of the first pattern may define borders of the laminate. The method may also include applying a second transparent substrate to the base layer. The second transparent substrate may include a second pattern correlating to the first pattern. The method may include identifying at least one feature from one or both one of the first pattern or the second pattern as a registration mark. The method may include determining a position of a cutting apparatus relative to the sheet of laminates based at least in part on the registration mark. The method may include cutting the sheet of laminates according to the position of the cutting apparatus relative to the registration mark such that the borders of the laminate are within a predetermined threshold.

### BACKGROUND

Precious metal laminates may be used as currency, certificates, collectibles, and/or other sources of value. The integrity of each precious metal laminate may be key to guaranteeing the value of a particular precious metal laminate, as the amount of precious metal in each laminate may be a known value. If the precious metal is gold (with a current price of over $2000/oz), even a 10% difference in the expected amount of precious metal in the laminate may cause losses. Furthermore, the value of the precious metal(s) used in such a laminate may create an incentive for bad actors to tamper with the laminates. For example, a bad actor may trim or otherwise remove a portion of the laminate to recover a portion of the precious metal, while leaving the laminate largely intact. This trimming may be difficult to detect and may enable a bad actor to trim numerous laminates to gradually accumulate a valuable quantity of the precious metal. Similarly, laminates may be utilized to secure data, such as encryption keys and other sensitive data, such as by providing the sensitive data within an interior of the laminate where the data cannot be accessed without tampering with the laminate. However, bad actors may be able to cut or otherwise tamper with edges of the laminate to gain access to an interior of the laminate while visibly leaving any marks of tampering. Some conventional laminates attempt to address these issues by creating laminates with clear borders that extend beyond the periphery of base layers (e.g., metal layers) of the laminate. Such laminates may provide evidence of tampering when the clear border is trimmed to expose a portion of the base layer. However, these clear borders may unnecessarily increase the size and quantity of materials of the laminate while also damaging the aesthetic of the laminate. In fact, the borders may hide uneven cutting and enable bad actors to hide clipping. Additionally, it may be possible for a bad actor to tamper with the edges of the laminate and re-laminate and/or otherwise repair the damage to the clear border to tamper with the laminate. Therefore, improvements to laminates to prevent edge tampering are desired.

Cut registration, as well as front to back print registration, is a known and persistent problem with roll-to-roll media as well as currency. Roll to roll media may present difficulties in any form of registration, because microscopic intolerances will multiply over each iteration, quickly becoming visible to the eye. For example, a 0.1 mm error in registration may become 1 mm in ten rows of bills and a full cm in 100 rows, cutting into the art of the media (e.g., a laminate) even if there is a very significant margin. Error correction may be difficult, because of the continuous nature of the physical rolls and the intended efficiency of continuous processes.

Laminate bills, which are almost always produced as web media because of cost, have had major problems with print registration that may be compounded by the nature of the metallic media. In the case of laminate bills, a number of post-printing cutting processes were pioneered through the 2010s, but machine-cut bills could not rival hand-cut bills for quality until approximately 2021. Another solution may be to print individual bills after the metal is cut. However, this process may be laborious and inefficient.

U.S. currency provides an example illustrating some of the difficulties of print registration with roll media. U.S. $1 bills are produced on rolls and can have visibly poor registration, despite major investment by the Bureau of Engraving and Printing and the fact that over ten billion $1 bills have been produced. U.S. currency also has a much larger margin on the back side than the front, to allow for poor front to back registration. In the much smaller field of metallic bills, through the 2020s, it was not possible to have dependable registration between cutting and printing. Margins were used to hide the poor tolerances between print and cut, because, for example, a 1 mm discrepancy between margins is less noticeable with an 5 mm margin (representing 20% variation), than if the margin were only 1.5 mm. These issues were so well known that professional grading services would grade a bill 70 perfect even with clearly visible, radically different margins. Thus, there is a need for improved registration of media (e.g., bills, laminates, etc.) both to improve the integrity of the media and to do so in a cost-effective manner.

### BRIEF SUMMARY

A method of producing a laminate may include forming a sheet of laminates. The method may include applying a base layer on a first transparent substrate may include a first pattern. At least a portion of the first pattern may define one or more borders of the laminate. The method may also include applying a second transparent substrate to the base layer. The second transparent substrate may include a second pattern correlating to the first pattern. The method may include identifying at least one feature from one or both one of the first pattern or the second pattern as a registration mark. The method may include determining a position of a cutting apparatus relative to the sheet of laminates based at least in part on the registration mark. The method may include cutting the sheet of laminates according to the position of the cutting apparatus relative to the registration mark such that the one or more borders of the laminate are within a predetermined threshold.

In some embodiments, the predetermined threshold may be 1 mm. The first pattern, the second pattern, and the registration mark may include an edge protection pattern. The method may include applying a second base layer to the first base layer. The first pattern and the second pattern may form a repeating pattern that extends continuous and/or discontinuously from the laminate to an adjacent laminate. The first pattern and/or the second pattern may be formed using ultraviolet sensitive ink.

In some embodiments, the method may include forming an area between at least two of the first transparent substrate layer, the first base layer, the second base layer, or the second transparent substrate layer. The area may be characterized by weak adhesion between the layers. The method may include depositing a substance in the area. The substance may include at least one of cobalt or ink.

A laminate may include a first transparent substrate layer may include a first pattern at least partially defining borders on the first transparent substrate. The laminate may include a base layer deposited on the first transparent substrate layer. The laminate may include a second transparent substrate formed on the base layer and include a second pattern. The second pattern may correspond to the first pattern such that an edge protection pattern is formed.

In some embodiments, the base layer may include at least one of a metal or a ceramic. A registration mark is included on the borders on the first transparent substrate and indicates a position of the laminate. The registration mark may be used to cut the laminate according to the borders within a predetermined threshold. The edge protection pattern may include a continuous and/or discontinuous pattern on two or more laminates. At least one of the first pattern or the second pattern may be formed using an oxidizing element. The base layer may include a third pattern characterized by raised and/or lowered features. The first pattern and the second pattern combine to form a curved line along at least a portion of the borders on the first transparent substrate. A registration mark may be included in the edge protection pattern. A registration mark may be formed independently of the first pattern and the second pattern. The edge protection pattern may reach within 0.25 mm of an edge of at least one of the borders.

A sheet of laminates may include a first transparent substrate layer may include a first pattern where at least a portion of the first pattern defines one or more borders of a plurality laminates. The sheet may include a base layer disposed on the first transparent substrate layer. The sheet may include a second transparent substrate layer may include a second pattern correlating to the first pattern. The first pattern and the second pattern may form an end protection pattern on at least one of the one or more borders such that the each of the plurality of laminates may include the edge protection pattern after cutting.

In some embodiments, a registration mark may be formed outside of the edge protection pattern in an area independent of the laminate. A machine-readable registration mark may be generated at a predefined location on the sheet of laminates within a tolerance of 1 μm. The machine-readable registration mark may be used to align a cutting tool such that the laminate is cut from the sheet of laminates by the cutting tool within a tolerance of 1 mm. The sheet of laminates may include a second base layer disposed on the base layer.

In some embodiments, a non-transitory computer-readable medium may include instructions that, when executed by one or more processors, cause the one or more processors to perform operations. The operations may include forming a sheet of laminates. The operations may include applying a base layer on a first transparent substrate including a first pattern. At least a portion of the first pattern may define one or more borders of the laminate. The operations may include applying a second transparent substrate to the base layer. The second transparent substrate may include a second pattern correlating to the first pattern. The operations may include identifying at least one feature from one or both one of the first pattern or the second pattern as a registration mark. The operations may include determining a position of a cutting apparatus relative to the sheet of laminates based at least in part on the registration mark. The operations may include cutting the sheet of laminates according to the position of the cutting apparatus relative to the registration mark such that the one or more borders of the laminate are within a predetermined threshold.

### BRIEF DESCRIPTION OF THE DRAWINGS

FIGS. 1A-C illustrates a laminate, according to certain embodiments.

FIG. 2 illustrates a sheet of laminates, according to certain embodiments.

FIG. 3 illustrates a sheet of laminates, according to certain embodiments.

FIG. 4A illustrates a first layer with a first pattern, according to certain embodiments.

FIG. 4B illustrates a second layer with a second pattern, according to certain embodiments.

FIG. 4C illustrates a laminate with an edge protection pattern, according to certain embodiments.

FIG. 5 illustrates a laminate with an edge protection pattern, according to certain embodiments.

FIG. 6 illustrates a laminate with an edge protection pattern, according to certain embodiments.

FIG. 7 illustrates a flowchart of a method for producing a laminate, according to certain embodiments.

FIG. 8 illustrates an apparatus for producing a laminate, according to certain embodiments.

FIG. 9 illustrates an exemplary computer system, in which various embodiments may be implemented.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Some laminates may utilize a precious metal (or metals) in order to guarantee value of the laminate. However, the value of the precious metal(s) used in the laminate may incentivize tampering. For example, a bad actor may remove a small portion of the laminate in order to access the precious metal(s) in the portion. If the portion is small enough, the tampering may not be readily apparent upon casual inspection of the laminate. Thus, the tampered laminate may be utilized (e.g., to trade) based on an assumed value that is no longer accurate due to the tampering. For example, if the laminate includes gold, a 10% reduction by edge clipping (e.g., removing material from one or more edges of the laminate) may result in major losses for subsequent holders of the laminate. Some laminates may additionally or alternatively store secure data for verifying the authenticity of the laminate or providing other such information. Removal of a portion of the laminate may result in unauthorized access to the data and/or the data being lost or unusable, potentially rendering the laminate less functional and/or valuable. In order to discourage tampering, increasing the trustworthiness of the laminate, the laminate may be designed to include tamper-resistant security features.

Embodiments of the present invention are directed to laminates that include secure information and/or precious metal laminates, as well as methods of making such laminates. Embodiments of the laminates include one or more advanced tamper-resistant security features that help protect the integrity of the secure information and, in some embodiments, may serve to verify the authenticity of the laminate itself. In some embodiments, the security features may be tamper-evident, such that users know if a particular laminate has been tampered with and may therefore render the note invalid. For example, an edge protection design may be created such that any tampering, and in particular tampering with the edge of the laminate, may be evident upon casual inspection. The edge pattern may include several points, arcs, etc. that reach (or nearly reach) the edge of a laminate. Any edge clipping may disturb the edge protection pattern, and any holder of the laminate may know that the laminate has been tampered with. Because the integrity of laminate may be readily observable, the laminate may be used as physical manifestations for electronic transactions, including serving to physically transfer value recorded on a blockchain, and/or may be used for protecting other secure information.

However, in order to implement security features such as edge clipping protection, other characteristics of the laminates may need to be controlled in order to enable precise printing of the security features. For example, conventional gold bars and foil bills are typically milled and then can be trimmed to achieve a precise weight (mass) of gold or other material.

However, this may result in bars bills that are non-uniform in surface area, which can be hidden with large margins. When the security features are implemented through a process such as printing, the non-uniformity of the bills may result in non-uniform security features. Thus, the laminates may include a uniform thickness, allowing for a uniform surface area of each laminate. Furthermore, various layers of a laminate may stretch as they are adhered, in different amounts lengthwise and width wise according to controlled tension and heat, and to a different extent than metallic layers of the laminate. To account for this, dimensions of each layer may be shifted and tuned to be the correct size. The security features may then be precisely printed on the bills, allowing for uniform security features across several different bills.

While discussed largely in the context of financial instruments, it will be appreciated that the laminates and related methods of manufacture may be utilized in numerous other applications where there is a need for tamper-resistant data security techniques.

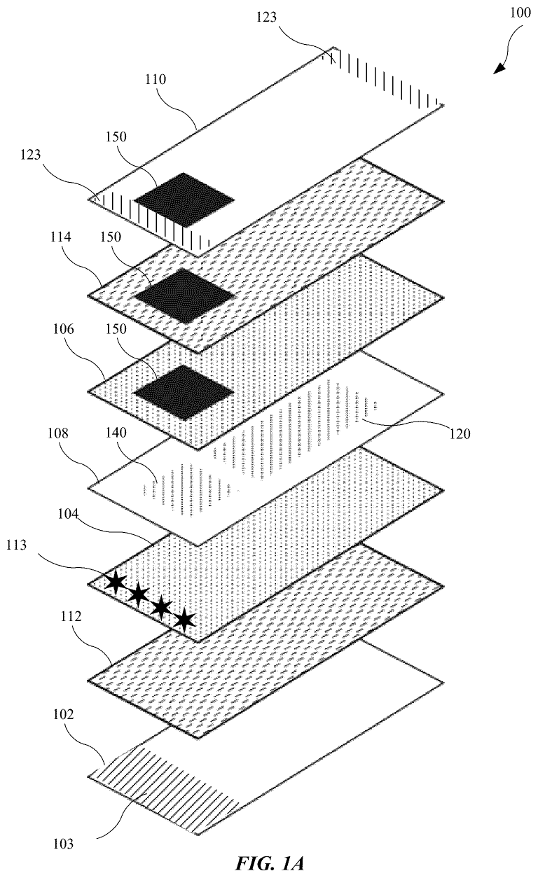

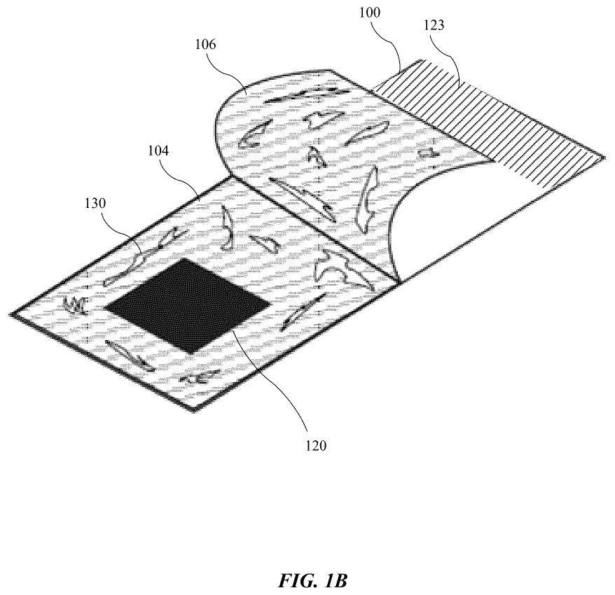

FIG. 1 illustrates a laminate 100, according to certain embodiments. The laminate 100 may be a single laminate cut from a sheet of laminates (e.g., the sheet of laminates 200 in FIG. 2). The laminate 100 may include a number of layers that are coupled or otherwise secured together. For example, laminate 100 may include a first substrate 102. The substrate 102 may have a length, width, and a thickness. The length and width may define outer boundaries of the laminate 100. The substrate 102 may be formed from polymeric and/or other transparent materials. For example, the substrate 102 may be formed from polyethylene terephthalate (PET), polyvinyl chloride (PVC), an acetate, a polycarbonate, a polyester, a polystyrene, a polypropylene, a polyethylene, polyvinylidene dichloride (PVDC), other polymers, and/or combinations thereof. Oftentimes, the thickness of the substrate 102 may be between about 25 microns and 200 microns, although other thicknesses are possible in some embodiments. In some embodiments, rather than being fully transparent, the substrate 102 may be translucent. In some embodiments, a dye or other coloring agent may be applied to at least particularly color the substrate 102.

The first substrate 102 may include a first pattern 103. The first pattern 103 may be formed by applying ink, other pigments, release material and/or adhesive material to the first substrate 102, by magnetic ink or pigment, by electrically charged material, by chemically altered material, and/or using other techniques. In some embodiments, the first pattern 103 may be applied using an ultraviolet (UV)-sensitive ink, oxidizing material, or other such material. Thus, if the laminate 100 is tampered with or otherwise altered, some or all of the first pattern 103 may be altered and may indicate damage and/or tampering.

An oxidizing material, as used herein, may include one or more molecules that may indicate tampering by altering certain characteristics when exposed to oxygen. For example, the first pattern 103 may include chromogenic compounds and/or colormetric sensors such as indigo carmine, which turn from blue to green upon oxidation. Thus, if the laminate 100 is tampered with (e.g., trimmed or clipped), some or all of the first pattern 103 may be green when it should be blue. Additionally, or alternatively, methylene blue may be used. Then, portions of the first pattern 103 may be invisible/colorless if untampered with. However, when exposed to oxygen, the exposed portions including methylene blue may turn from colorless to blue.

In another example, fluorophores (oxygen or nitrogen sensitive), molecular probes, molecular sensors, fluorogenic redox sensors, and/or chemiluminescence molecules (collectively, “fluorescents”) may be included in some or all of the first pattern 103. When exposed to O2 or N2, the fluorescents may bind and compete for pi conjugation. The fluorescents may be complexed in a polymer cell to limit gas exposure unless completely exposed, such as through tampering. The polymer cell may restrict a gases ability to access the fluorescents such that only significant exposure to gas may activate the fluorescents.

In yet another example, other molecules may be included in the first pattern 103 that may interact with the other molecules and “turn off” fluorescence. The other molecules may include porphyrins, ruthenium-containing compounds, platinum and palladium ligand complexes, phosphorescent boron and aluminum chelates, pyrenes, and other such molecules. Oxygen may react with the other molecules and form a complex and/or break conjugation of pi bonds and decrease the intensity of fluorescence of the other molecules. If tampered with, the laminate 100 (e.g., portions of the first pattern 103) may display a lower intensity of fluorescence. In still other examples, the first pattern 103 may include, nitrogen doped carbon dots, dichlorofluorescein, dihydroxyphenylalinine, phenanthridines, Hydroethidine, and/or other materials.

The first pattern 103 may be a continuous and/or discontinuous pattern along an edge of the laminate 100 (as shown in FIG. 1A). In other embodiments, the pattern 103 may include figures, lines, shapes, etc. along only a portion of the edge. In some embodiments, the first pattern 103 may be formed along an entire length and/or a portion of a length of multiple edges of the laminate 100. At least a portion of the first pattern 103 may form a registration mark. The registration mark may be a machine-readable registration mark, a visible (e.g., human-readable) registration mark, or any other suitable type of registration mark. In some embodiments, the registration mark may be invisible to the naked eye. The registration mark may be generated using infrared ink, ultraviolet ink, or any other suitable substance such that the registration mark is visible in certain conditions (e.g., under UV light, etc.), while being invisible to the naked eye. The registration mark may be used by a cutting apparatus to identify a position of the cutting apparatus in relation to the laminate 100 (and/or the sheet of laminates). For example, the cutting apparatus may include a laser, optical reader, or other suitable sensor capable of identifying a size, shape, orientation, location, and/or other feature of the registration mark on the laminate 100. The cutting apparatus may also include a laser and/or a reading eye (e.g., camera), and may calculate where the printed media is relative to the center of the mark. For example, a registration mark may include a 5 mm square. The cutting apparatus may locate a center a center (or other position) of the box and use this known location as a reference coordinate that is used to calculate locations for the various features of the laminate.

After identifying the registration mark, the cutting device may cut or otherwise divide the sheet of laminates to produce the laminate 100. The registration mark may allow the laminate 100 to be produced within a tolerance of about 0.1 mm or less, about 0.5 mm, about 1 mm, about 2 mm, about 3 mm, etc. For example, the length and width of the laminate 100 may be associated with respective desired measurements (e.g., the desired length may be 150 mm). The registration mark may therefore allow the length of the laminate 100 to be cut within a range of 19 mm to 21 mm, inclusive. Furthermore, the registration mark may allow the laminate 100 to be cut within a tolerance of a desired dimension(s). For example, the laminate 100 may be cut to within about 95% of the desired dimension(s), about 97% of the desired dimension(s), about 99% of the desired dimension(s), 99.5% of the desired dimension(s), etc. One of ordinary skill in the art would recognize many different possibilities and configurations.

The laminate 100 may include two or more metallic (or otherwise opaque) layers. For example, laminate 100 may include a first base layer 104 that is positioned proximate the substrate 102 and a second base layer 106 that is positioned proximate the first base layer 104. Each base layer 104, 106 may be formed from various materials. For example, the base layers 104, 106 may be a crystalline layer. Crystalline layers may include metallic materials and/or ceramic materials in some embodiments. For example, the base layers 104, 106 may include ceramic materials such as, but not limited to, aluminum oxide, beryllium oxide, zirconium oxide, and/or other ceramic materials. The base layers 104, 106 may include metallic layers and may be formed from any type of precious and/or non-precious metal. For example, each base layer 104, 106 may be formed of gold, silver, platinum, palladium, rhodium, osmium, iridium, ruthenium, rhenium, indium, germanium, beryllium, tellurium, bismuth, aluminum, bronze, copper, nickel, cobalt, titanium, lanthanides, and/or other metals and/or alloys. In some embodiments, other opaque materials may be used in addition to, or in place of the base layers. Each base layer 104, 106 may be applied as a precisely measured quantity of one or more metals. For example, a quantity of metal deposited and/or otherwise applied may be measured by mass and/or thickness. In specific examples, the metal may be present in quantities of between about 25 mg to 2520 mg. In some embodiments, the metal may be applied at thicknesses of between about 96 nm and 8000 nm, and more commonly between about 200 nm and 6000 nm. In some embodiments, non-precious metal base layers may have thicknesses as low as about 96 nm, while precious metal layers may have layers as thin as about 200 nm. In some embodiments, the base layers 104, 106 may be the same, while in other embodiments, the base layers 104, 106 may have different compositions, thicknesses, other dimensions and/or other characteristics.

In some embodiments, the base layers 104, 106 may each be applied as a single planar or non-planar layer. However, oftentimes, one or both of the base layers 104, 106 may be applied as a number of sublayers, which may increase the precision of the application process, as well as enable more intricate designs of the precious metal. Any number of sublayers may be present within a given base layer 104, 106. In some embodiments, each of the sublayers may have a same thickness, while in other embodiments, one or more of the sublayers may have different thicknesses. For example, lower (first-applied) sublayers may be applied at greater thicknesses than upper (later-applied) sublayers. Such an arrangement may be particularly useful, as this may allow the later-applied sublayers to be thinner, more precisely controlled layers that may enable a total thickness of the sublayers to be carefully controlled to ensure that a substantially precise amount of metal is applied to the laminate 100. It will be appreciated that thicker layers may be applied as upper layers in some embodiments. Additionally, some embodiments may have sublayers that are arranged in any order in relation to thickness of each sublayer. In some embodiments, a substantially precise amount of metal is within about 20% of a desired target amount (such as a thickness and/or mass), within about 15% of the desired target amount, within about 10% of the desired target amount, within about 7.5% of the desired target amount, within about 5% of the desired target amount, within about 4% of the desired target amount, within about 4% of the desired target amount, within about 3% of the desired target amount, within about 2% of the desired target amount, within about 1% of the desired target amount, within about 0.9% of the desired target amount, within about 0.8% of the desired target amount, within about 0.7% of the desired target amount, within about 0.6% of the desired target amount, within about 0.5% of the desired target amount, within about 0.4% of the desired target amount, within about 0.3% of the desired target amount, within about 0.2% of the desired target amount, within about 0.1% of the desired target amount, within about 0.05% of the desired target amount, or less.

In some embodiments in which a base layer 104, 106 is generally flat, the base layer 104, 106 may have a thickness that is uniform across a surface area of the base layer 104, 106 to within 15%, within 10%, within 5%, within 3%, within 2%, within 1%, within 0.5%, within 0.025%, within 0.01% or less.

In some embodiments, to enable the precise application of a base layer 104, 106, a number of sublayers may be applied and a total thickness of these sublayers may be measured prior to the application of one or more final sublayers. Based on the measured thickness, a thickness of the one or more final sublayers may be determined to achieve a desired total amount of the precious metal. The one or more final sublayers may then be applied to the prior-applied sublayers to create a base layer 104, 106 having a desired thickness and/or cross-sectional shape.

In some embodiments, the sublayers may be generally flat and/or uniform, however in other embodiments, one or more of the sublayers may have a non-flat shape and/or be otherwise non-uniform across a length and/or width of the sublayer. For example, sublayers may include one or more tapers, contours, and/or other transitions between thick and thin portions. In some embodiments, sublayers having different directions of taper may be arranged together, alternate, and/or provided in another arrangement. In some embodiments, the taper may be constant, while in other embodiments the taper may be curved and/or otherwise variable. Additionally, in some embodiments one or more of the sublayers may be flat and/or otherwise shaped. The arrangement of sublayers may create a generally flat base layer 104, 106, or may produce a base layer 104, 106 with one or more raised and/or lowered areas. The contours may include any number of concave and/or convex areas. In some embodiments, the various contours, tapers, etc., of the various sublayers may combine to form a generally flat or planar base layer 104, 106, while in other embodiments, one or both of the base layers 104, 106 may be non-planar. It will be appreciated that contours, such as convex and/or concave portions, may be symmetrical and/or may include asymmetrical portions. In some embodiments, a single sublayer may include one or more flat/planar portions, tapered portions, and/or concave/convex portions.

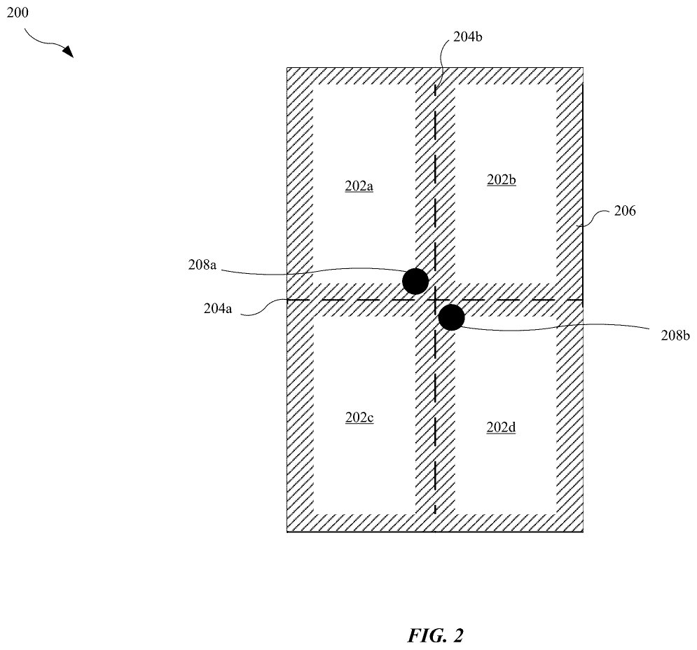

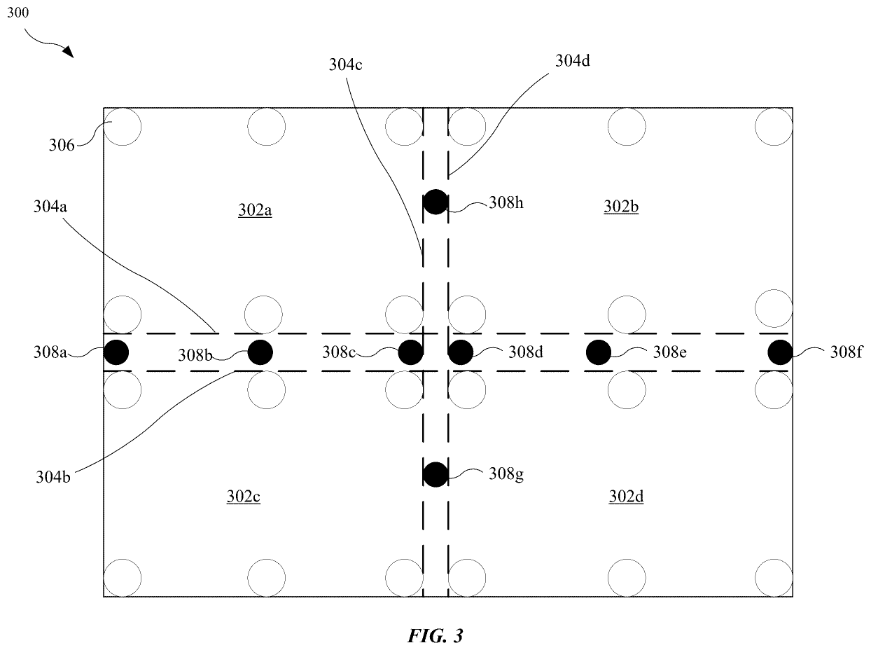

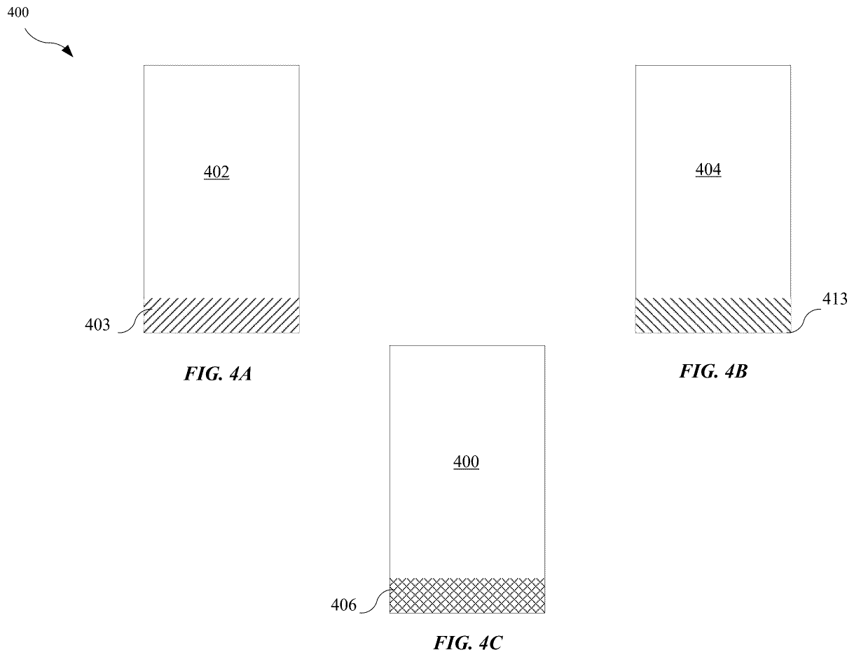

In some embodiments, the contours may form a second pattern 113. The pattern may correlate to the first pattern 103. “Correlate,” as used herein, may mean the second pattern 113 may be different than the first pattern 103 and form a combined pattern with the first pattern 103 when the laminate 100 is completed (e.g., as is described in relation to FIG. 4). “Correlate” may also mean that the second pattern 113 is identical or at least partially different from the first pattern 103. The second pattern 113 may be formed with the substance of the base layer 104 (and/or the base layer 106), or may be applied to the base layer(s) 104 and/or 106 (e.g., via etching, printing, laser, or other suitable methods). Although the laminate 100 illustrates the first pattern 103 and the second pattern 113 present at the simultaneously, it should be understood that the laminate 100 may include both, one or the other, or neither of the first pattern 103 and the second pattern 113.

The various sublayers may be coextensive with one another, while in other embodiments, one or more of the sublayers may extend beyond the outer peripheries of one or more other sublayers. In some embodiments, one or more (possibly all) sublayers may define gaps within an interior of the given sublayer. This may create a portion of the base layer 104, 106 that is thinner than a remaining portion or that is entirely devoid of metal to create a transparent or translucent window. In some embodiments, if the thin portion is sufficiently thin, the thin portion may serve as an authentication feature. As just one example, if the metal is gold and the thin portion is less than about 200 nm in thickness, the gold may appear turquoise when light is shined through the thin portion. This particular optical transmission feature is unique to gold and may enable users to quickly discern whether the laminate 100 actually contains gold, rather than some counterfeit material, as this is a very difficult property to replicate, even with the use of dyes. These thin portions may be of any shape and/or size. In some embodiments, these thin portions may be used to generate intricate designs. As just one example, thin areas in different sublayers (or a single sublayer) may be deposited to form an image. This image may have unique optical properties that serve as an authentication measure and/or provide a unique aesthetic quality. In one particular embodiment, the thin portions may define a clover design, with each of the leaves being translucent. As noted above, if the translucent portions are gold, the leaves may look turquoise as lighted is shined through the clover. In some embodiments, a thickness of one or more of the leaves may be different, which may provide unique light transmission properties through the different leaves.

In some embodiments, the sublayers may have different shaped profiles along different axes of the laminate 100. For example, along a length of the laminate 100, one or more of the sublayers may have a tapered profile, while along a length of the laminate 100, one or more of the sublayers may have a concave/convex profile. In some embodiments, a single sublayer may have two different profile shapes along different axes, such that when viewed from the side the sublayer may have a first shape and when viewed from an end the sublayer may have a second shape. Embodiments may therefore have sublayers that have very complex deposition (or other application) patterns. In some embodiments, boundary lines of the various sublayers may be visible to the naked eye, while in other embodiments the sublayer boundaries may be invisible without the aid of magnifying implements. In some embodiments, a marker material may be used to distinguish between the different sublayers.

Each base layer 104, 106 may include textures and/or surface finish. The surface finish and/or texture of the first base layer 104 may be the same or different than a surface finish and/or texture of the second base layer 106. For example, each base layer 104, 106 may have a polished finish to increase the shine and/or reflective properties of the precious metal. Various finishes may include antique finishes, brushed finishes, hammered finishes, satin finishes, and/or oil-rubbed finishes. Various textured may include grooves, diffraction gratings, and the like. Additionally, various textures may be applied to the base layer 104, 106. In some embodiments, an entire outer/exposed surface of the base layer 104, 106 may have a single surface finish/texture, while in other embodiments one or more portions of the exposed surface of the base layer 104, 106 may have different finishes/textures. For example, a first major surface (such as the bottom surface) of the base layer 104 may have a first finish/texture while a second opposite major surface (such as the top surface of the second base layer 106) may have a second, different finish/texture. Additionally, in some embodiments, multiple portions of the base layer 104, 106 on a single major surface may have different surface textures/finishes. This may be particular useful in embodiments in which a portion of the base layer 104, 106 is used to define a shape, text, and/or other image for security, aesthetic, and/or other purposes. For example, a main portion of the surface of the base layer 104, 106 may have a first surface finish/texture, while a smaller portion of the surface having a desired shape, text, and/or other image may have a different surface finish/texture. This may enable the smaller portion to be easily distinguished from the main portion.

In some embodiments, the base layer 104, 106 may include feathering, such as near the edges of one or more of the sublayers. The feathering may be a lateral reduction of the thickness of the base layer 104, 106 and/or one or more of the sublayers. This may be used to create precisely thinned regions, which may provide unique optical characteristics, such as those described above. The use of feathering may create a laminate 100 that is particularly difficult to counterfeit. In some embodiments, the feathering may have an optical density ranging from 1 to 4. In some embodiments, a dielectric material may be printed on or otherwise deposited on a portion of the base layer 104, 106. The dielectric material may have a thickness that is between 0.25 to 1.5 of a quarter wave thickness. The thickness may be selected to produce various colors when light is reflected off of the dielectric material.

The laminate 100 may include security information 120, such as one or more codes, serial numbers, account numbers, personal information items, informational features, encryption keys, pin numbers, authentication information/images, and/or other sensitive information. The security information 120 may be provided on the laminate 100 in such a manner that that the security information 120 is not visible from outside the laminate 100. For example, the security information 120 may be embedded within and/or between the base layers 104, 106 such that the security information 120 is hidden and protected by the base layers 104, 106 (and/or other metallic/opaque layers of the laminate 100) and/or by a number of security features of the laminate 100. The hidden security information 120 may then only be accessed by delaminating the laminate 100, as will be discussed in greater detail below. Oftentimes, the security information 120 may be printed and/or otherwise provided between at least two opaque layers of the laminate 100. For example, the security information 120 may be printed on inner-facing surfaces of one or both of the base layers 104, 106 (or other opaque layers of the laminate 100). In some embodiments, alternatively or in addition to providing security information 120 on inner-facing surfaces of one or both of the base layers 104, 106, a separate security layer 108 may be provided between the base layers 104, 106. Security information 120 may be printed on, formed in and/or on, or otherwise provided on and/or in the security layer 108. The security information 120 may be formed applying ink, other pigments, release material and/or adhesive material to one or more of the layers of the laminate 100, by adding and/or removing material from one or more layers of the laminate 100 (such as the material forming the respective layer), by magnetic ink or pigment, by electrically charged material, by chemically altered material, and/or using other techniques. The security information 120 may be provided in human readable and/or computer-readable forms (such as barcodes, QR codes, etc.). In some embodiments, some or all of the security information 120 may be encoded in a digital form. For example, the security information 120 may be encoded on a radio frequency (RF) chip that may be affixed and/or otherwise provided on the base layers 104, 106 and/or a security layer 108. In some such embodiments, the laminate 100 may include one or more RF blocking layers (which may be formed by the base layers 104, 106 and/or other layers of the laminate 100 and/or be formed as separate layers) that may prevent interrogation of the RF chip until the laminate 100 is delaminated to provide unimpeded access to the RF chip.

The security layer 108 may be formed of any material and include opaque, translucent, and/or transparent portions. For example, the security layer 108 may be formed of natural materials (such as paper, natural fibers, wood, and/or composites thereof), synthetic materials (polymers, synthetic fabrics, glass, ceramic, etc.), metals (precious or non-precious), and/or combinations thereof. While shown with a single security layer 108, it will be appreciated that any number of security layers (which may be identical or different) may be utilized and that some embodiments may omit a security layer entirely. As will be discussed in greater detail below, the laminate 100 may include other security features, which may be provided on any layer of the laminate 100 including the security layer 108 and/or a separate layer.

In some embodiments, the laminate 100 may include a second substrate 110 that covers the second base layer 106. Substrate 110 may help protect the second base layer 106 from damage associated with handling, misuse, and/or exposure to the environment. This may be particular useful when metals such as copper, brass, nickel, silver, etc., are used, which may be subject to oxidization. The substrate 110 may be identical to or similar to the substrate 102. In other embodiments, the substrate 110 may be quite different from the substrate 102. In some embodiments, the substrate 110 may be formed of a same or similar material as substrate 102. For example, the substrate 110 may include polyethylene terephthalate (PET), polyvinyl chloride (PVC), an acetate, a polycarbonate, a polyester, a polystyrene, a polypropylene, a polyethylene, polyvinylidene dichorlide (PVDC), other polymers, and/or combinations thereof. Oftentimes, the substrate 110 may have a thickness of between about 25 microns and 200 microns.

The second substrate 110 may include a third pattern 123. The third pattern 123 may be formed by applying ink, other pigments, release material and/or adhesive material to the second substrate 110, by magnetic ink or pigment, by electrically charged material, by chemically altered material, and/or using other techniques. In some embodiments, the third pattern 123 may be applied using an ultraviolet (UV)-sensitive ink, oxidizing material (e.g., those described in relation to the first pattern 103, above), or other such material. Thus, if the laminate 100 is tampered with or otherwise altered, some or all of the third pattern 123 may be altered indicating damage and/or tampering.

The third pattern 123 may be a continuous and/or discontinuous pattern along an edge of the laminate 100 (as shown in FIG. 1A). In other embodiments, the pattern 103 may include figures, lines, shapes, etc. along only a portion of the edge. In some embodiments, the third pattern 123 may be formed along multiple edges of the laminate 100. The third pattern 123 may correlate to the first pattern 103 and/or the pattern in included in the base layers 104 and 106. “Correlate,” as used herein, may mean the third pattern 123 is different than the first pattern 103 and forms a combined pattern with the first pattern 103 when the laminate 100 is completed. “Correlate” may also mean that the third pattern is identical or at least partially different from the first pattern 103.

At least a portion of the third pattern 123 may form a registration mark. The portion of the third pattern 123 may form the registration mark alone and/or in combination with the first pattern 103. The registration mark may be a machine-readable registration mark. The registration mark may be used by a cutting apparatus to identify a position of the cutting apparatus in relation to the laminate 100 (and/or the sheet of laminates). For example, the cutting apparatus may include a laser, optical reader, or other suitable sensor capable of identifying the registration mark on the laminate 100. After identifying the registration mark, the cutting device may cut or otherwise divide the sheet of laminates to produce the laminate 100. The registration mark may allow the laminate 100 to be produced within a tolerance of less than or equal to about 0.1 mm, about 0.2 mm, about 0.3 mm, about 0.4 mm, about 0.5 mm, about 1 mm, about 2 mm, about 3 mm, etc. For example, the length and width of the laminate 100 may be associated with respective desired measurements (e.g., the desired length may be 150 mm, 160 mm, 180 mm, etc.). The registration mark may therefore allow the length of the laminate 100 to be cut within a range of 19 mm to 21 mm, inclusive. the laminate 100 may be cut to about 95% of the desired measurements, about 97% of the desired measurements, about 99% of the desired measurements, about 99.5% of the desired measurements, etc. One of ordinary skill in the art would recognize many different possibilities and configurations.

In some embodiments, the laminate 100 may include only two metallic (and/or otherwise opaque) layers. In some such embodiments, the first substrate 102 and/or second substrate 110 may be applied directly to one of the base layers 104, 106, such as by using an adhesive. In some embodiments, additional base layers may optionally be included. For example, in some embodiments, an intermediate base layer 112 may be positioned between the first base layer 104 and the substrate 102 and/or an intermediate base layer 114 may be positioned between the second base layer 106 and the second substrate 110. The intermediate layers 112, 114 may be coupled with a respective one of the substrates 102, 110. In some embodiments, this may involve the use of an adhesive that is applied between the respective substrate 102, 110 and intermediate layer 112, 114.

In some embodiments, the intermediate layers 112, 114 may be identical to one another, while in other embodiments, the intermediate layers 112, 114 may be different. For example, the material, thickness, pattern, surface finish, texture, and/or characteristic of the intermediate layers 112, 114 may be different from one another. In some embodiments, one or both of the intermediate layers 112, 114 may be identical to one or both of the base layers 104, 106, while in other embodiments, one or both of the intermediate layers 112, 114 may have different materials, thicknesses, patterns, surface finishes, textures, and/or characteristics than one or both of the base layers 104, 106. In some embodiments, one or both of the intermediate layers 112, 114 may include one or more security features and/or security information, such as that described above.

As disclosed above, in some embodiments, the substrates 102, 110 may each be applied directly to one of the base layers 104, 106 and/or intermediate base layers 112, 114. However, in other embodiments, an additional transition layer may be formed between the respective base layer and the substrate 102, 110. This may be particularly useful in embodiments in which the base layer being secured to the substrate 102, 110 includes certain precious metals (such as, but not limited to, gold), which may present bonding challenges. In such embodiments, a transition layer may be deposited and/or otherwise applied to the processed inner surface of the respective substrate 102, 110. The transition layer may provide several benefits. For example, the transition layer may enable a thinner substrate 102, 110 to be utilized, while still providing stability to the laminate 100. The use of a transition layer may also help balance heat load during deposition processes and may help achieve greater performance. In particular, the transition layer may help increase the adhesion of precious metals to the substrate 102, 110. The transition layer may be transparent in order to enable the aesthetic properties of the base layers to remain visible from an outside of the laminate 100, as well as to enable a window 150 to be transparent and/or translucent. In some embodiments, the transition layer may include one or more transition metals. Oftentimes, the transition metals may include oxides and/or carbides. For example, the transition layer may include nickel alloys, titanium, vanadium, chromium, zirconium, niobium, molybdenum, hafnium, tantalum, tungsten, nickel chromium alloys, titanium carbide, titanium oxide, and/or titanium zirconium. Oftentimes, the transition layer may have a thickness of between about 0.5 nm and 10 nm.

In some embodiments, some or all of an inward-facing surface of one or both substrates 102, 110 may be processed and/or otherwise prepared prior to being coupled with inner layers of the laminate 100. For example, a portion of the inner surface may be removed using a pretreat such as, but not limited to, plasma, sodium hydroxide, sputtering, etc. Hydrogen atoms may be blown off and/or oligomers may be removed. This processed surface may create better adhesion between the substrate 102, 110 and the adjacent inner layers, especially when the adjacent layers include a precious metal.

As indicated above, at least some of the security information 120 may be hidden and protected by opaque layers of the laminate 100, such as the base layers 104, 106. Therefore, to access this hidden security information 120, a user must delaminate at least a portion of the laminate 100. In particular, the user must separate the opaque layer that is most proximate the obscured security information 120 from the layer on which the security information 120 is provided in order to gain visual access to the security information 120. Delamination may be performed in various manners, the most common of which is to peel or otherwise mechanically separate the respective layers. However, in some embodiments, alternatively or in addition to peeling, the laminate 100 may be delaminated using a mask to break adhesion, by applying heat to the laminate 100, splitting the laminate, and/or using a chemical solvent. In some embodiments, all of the security information 120 and/or other hidden information may be hidden between a single pair of layers of the laminate 100 such that a single delamination step is required to access all of the hidden information. In other embodiments, the security information 120 and/or other hidden information may be hidden between multiple pairs of layers such that multiple delamination steps are necessary to access all of the hidden information.

To prevent a user from delaminating the laminate 100 to access the security information 120 and then re-laminating or otherwise reassembling the laminate 100, the laminate may include one or more tamper-resistant and/or tamper-evident features that may alert users that the integrity of the laminate 100 has been compromised. For example, color changing materials (such as those that easily oxidize described in relation to the first pattern 103) may be provided on or proximate the layer on which the security information 120 is provided such that any delamination to access the security information 120 will result in irreversible damage 130 that manifests as readily identifiable color changes to the area around the security information 120 that indicate previous tampering has occurred. The color change materials may include inks, adhesives, dyes, quickly oxidizing (or otherwise corroding) metals (such as certain purities and/or alloys of silver), color change threads, and/or other substances. Some of the materials forming the layer on which the security information 120 is provided and/or adjacent layers may be designed to break, metal may be turned into flakes and/or powder in a random or selected pattern, a material may be partially removed, atomize, and/or otherwise become irreversibly damaged upon delamination. For example, the one or more of the metallic and/or intermediate layers may atomize and/or otherwise break (oftentimes with some of the metal remaining adhered to a separate layer (such as one of the substrates 102, 110, and/or other transparent/translucent layer) while a majority of the metal is separated during delamination) and/or otherwise be removed, which leaves very visible instances of irreversible damage 130 as shown in FIG. 1B. In some embodiments, the irreversible damage 130 may include folds and/or creases being permanent formed within the laminate 100, breaking of one or print layers (which may include the security information 120 and/or include other information, such as identification information as described elsewhere herein), breaking of security threads (such as color-shift threads), separation of one or more print layers onto distinct surfaces of the laminate 100, and/or and de-metallization of holograms (when included). Oftentimes, this irreversible damage 130 may be visible from an outside of the laminate 100. This allows a user to view damage to the laminate 100 and determine that the laminate 100 has been previously delaminated and/or otherwise tampered with. In some embodiments, the irreversible damage 130 may include tearing of one of more of the layers of the laminate 100. In some embodiments, tamper evident/resistant material, such as that described above, may be positioned about a periphery of the security information 120 such that to access the security information, the tamper-evident/resistant material must be broken.

Oftentimes, the irreversible damage 130 may be randomly oriented on the laminate 100 and may be generated by the particular position, force, and/or type of delamination used. In other embodiments, the construction of the laminate 100 may cause intentional irreversible damage at one or more locations (possibly in addition to random damage). For example, some areas of the laminate 100 may include stronger and/or otherwise different adhesives, some layers (such as the base layers 104, 106) and/or portions thereof may be applied using different techniques with different adhesion/bonding characteristics, some areas may utilize weaker materials that are positioned in designated areas, some layers may include pre-perforated sections that are designed to tear or otherwise become irreversibly damaged upon delamination, and/or other forms of location-specific irreversible damage mechanisms may be utilized.

In addition to the tamper resistant/evident features described above, the laminate 100 may include one or more text-based and/or image-based markings 140 that may serve as identifying marks and/or security features that may provide anti-counterfeiting and/or authentication means. For example, the first pattern 103, second pattern 113, and/or the third pattern 123 may form an edge protection pattern either alone or in combination. The edge protection pattern may provide a means to determine if an edge of the laminate 100 has been tampered with (e.g., trimmed). In some embodiments, tampering may be determined visually by observing the edge protection pattern. For example, the edge protection pattern may include a curve that approaches at least a portion of the edge of the laminate 100. If the edge has been trimmed, it may be obvious due to the curve not being completed. Additionally, or alternatively, the edge protection pattern may include a tamper-evident substance, invisible to the naked eye and used to create the first pattern 103, the second pattern 113, and/or the third pattern 123 (e.g., an oxidative material, UV visible material, etc.). If the edge of the laminate 100 is trimmed, exposing the first pattern 103, the second pattern 113, and/or the third pattern 123 to oxygen, the edge protection pattern may be altered indicating tampering. In other embodiments, the edge protection pattern may include a machine-readable code, such as a QR code, a bar code etc. Tampering may alter the ability of the machine-readable code to be determined, and thus indicate tampering. While described with respect to first pattern 103, second pattern 113, and third pattern 123, it will be appreciated that any number of patterns (which may operate independently and/or may correlate with one another) may be included on the laminate 100.

In some embodiments, the markings 140 may include one or more micro patterns, embossed areas, relief structures, holograms, laser-etched elements, lithographs, and/or diffraction gratings. In some embodiments, the markings 140 may provide identification of one or more pieces of information, such as a source of the laminate 100, a type of precious metal (if present) in the laminate 100, a purity of precious metal (if present) in the laminate 100, an amount of precious metal (if present) in the laminate 100, a value of the laminate 100, a serial number of the laminate 100, and/or other information.

In some embodiments, the markings 140 may include various security features including small/trace quantities of a metal (oftentimes different than the metal in the base layers 104, 106), embedded fibers, a dye coating (which may be fluorescent in some embodiments), a spectral-shifting coating or other treatment, particles (such as nanoparticles) having relatively unique spectral properties.

In some embodiments, the markings 140 may include a number of apertures formed through the laminate 100, one or more blind holes formed through a portion of the thickness of the laminate 100, one or more micro-damage elements (such as a contaminant distribution arrangements, depressions, and/or bas-relief surfaces). In some embodiments, all of the markings 140 and/or other security features may be provided on a single layer of the laminate 100, such as one of the base layers 104, 106, the security layer 108, one of the intermediate layers 112, 114, and/or one of the substrate layers 102, 110. In other embodiments, the markings 140 and/or other security features may be provided on multiple layers. In some embodiments, one or more of the markings 140 and/or other security features may be provided as a separate layer of material within the laminate 100. Some or all of the markings 140 may be visible at all times (such as by providing the marking 140 on an outer surface of the outermost opaque layer on a given side of the laminate 100 and/or by providing in on or in an outer transparent/translucent layer). In other embodiments, some or all of the markings 140 may be hidden by one or more opaque layers and thus be accessible only upon delaminating the laminate 100.

As indicated above, in some embodiments the markings 140 may include one or more holograms. In some embodiments, the holograph may be formed as part of and/or otherwise integrated directly inter one or more of the layers of the laminate 100. For example, the hologram may be formed as part of or formed onto one or more of the base layers 104, 106, intermediate layers 112, 114, security layer 108, and/or substrates 102, 110. In some such embodiments, the metallization of the hologram may be done using a base layer on which the hologram is formed. In other embodiments, a holographic sticker may be affixed to one of the interior layers of the laminate 100, which may protect the hologram from tampering without delaminating the laminate 100.

In some embodiments, the markings may include one or more relief structures. For example, a relief structure may be formed from depositing onto and/or removing material from one of the layers of the laminate 100. The relief structure may include one or more cavities or protrusions that define a random and/or patterned 3-dimensional structure within or on the laminate 100. The relief structure may be formed on an outer layer of the laminate 100 to provide the laminate with a 3-dimensional texture in some embodiments. In some embodiments, the relief structure may be formed on and/or coupled with an interior layer of the laminate 100. In some such embodiments, the outer layers (such as adhesives and/or substrates) may be applied in a manner (such as with uniform thickness) such that the outer layers have a contour matching the relief structure and therefore imparting the 3-dimensional texture on an outer surface of the laminate such as shown in FIG. 1C. In some embodiments, the outer layers may be applied with variable thickness such that one or more of the outer layers fill the voids in the relief structure while still providing a generally planar outer surface.

In some embodiments, adhesive layers may be provided between one or more adjacent layers of the laminate 100. For example, an adhesive layer may be disposed between the first base layer 104 and the second base layer 106 to secure the two layers together. As another example, adhesive layers may be applied on either side of the security layer 108 to help bond the security layer 108 to the base layers 104, 106. It will be appreciated that in some embodiments none of the layers of the laminate 100 are adhesively bonded, while in other embodiments all layers are adhesively bonded. Adhesive layers may be positioned between any two adjacent layers. The adhesive layers may be transparent, translucent, and/or opaque. In some embodiments, the adhesive layer may include an acid-resistant, heat resistant, and/or solvent-resistant binder, which may hinder the ability to tamper with the laminate 100 to access secure data provided within the area of the laminate 100 between the first base layer 104 and the second base layer 106 (such as on inner surfaces of one or both of the base layers 104, 106 and/or on one or more intervening layers, such as security layer 108). In some embodiments, the adhesive layer may serve as a tamper-evident security feature. For example, the adhesive layer may include an adhesive or other substance that changes color due to oxidation and/or trauma. For example, an adhesive that begins to oxidize when exposed to air may alert users if the first base layer 104 and second base layer 106 have been separated, as any portion of the adhesive layer that has been exposed due to the separation will be partially or fully oxidized, and thus a different color than the adhesive layer for an untampered-with laminate 100.

In some embodiments, the adhesive layer may include areas characterized by weak adhesion (in relation to other areas of the adhesive layers). A substance such as ink, a metal powder (e.g., cobalt), or other suitable substance may be disposed in the areas of weak adhesion. If the laminate 100 is tampered with, the substance may spill out of the laminate, indicating tampering.

In some embodiments, the laminate 100 may define one or more transparent and/or translucent windows 150 that enable a user to see through all or part of the laminate. For example, the window 150 may enable a user to optically view various layers of the laminate 100 other than the outermost metallic (or otherwise opaque) layers. Each window 150 may be positioned at any location within the boundaries of the laminate 100. In some embodiments, the window 150 may be centered within an interior of the laminate 100. In some embodiments, the window 150 may share one or more peripheral edges with the rest of the laminate 100. For example, the window 150 may form a border about all or a portion of the laminate 100. In some such embodiments, a border window 150 may reduce the amount of adhesion needed to form the laminate 100, as there may be less material (such as metals) deposited on or between the substrates 102, 110. In some embodiments, the window 150 may extend along two adjacent edges of the laminate 100 and/or contact two or more opposing/non-adjacent edges of the laminate 100. In some embodiments, all of the window 150 may be positioned inwardly of the peripheral edges of the laminate 100 such that the window 150 is framed by the various layers of the laminate 100, including the base layers 104, 106. Each window 150 may have any shape and/or size. In embodiments with multiple windows 150, each window 150 may be the same size and/or shape, or may be different. The windows 150 may be positioned symmetrically and/or asymmetrically about the laminate 100.

In some embodiments, the window 150 may extend through an entire thickness of the laminate 100, such that a hole is defined through an entire thickness of the laminate 100. The window 150 may be defined in one or more opaque layers (such as base layers 104, 106 and/or intermediate layers 112, 114), such as to expose a surface of one of the base layers 104, 106 through one or both of the intermediate layers 112, 114 and/or to expose the security layer 108. The window 150 may extend through one or both of the substrates 102, 110. It will be appreciated that window 150 may be defined through any combination of one or more layers of the laminate 100.

In some embodiments, one or more of the markings 140 and/or some of the security information 120 may be in alignment with the window 150 to enable such information to be visible from an outside of the laminate 100 via the window 150 without the need to delaminate the laminate 100. As just one example, a public encryption key is provided as marking 140 on one or more inner layers of the laminate 100 and visible via the window 150, while a corresponding private encryption key is hidden as protected security information 120 between two or more opaque layers. In some embodiments, the window 150 may extend to show layers in which tamper resistant/evident markings are provided. This may enable users to view any signs of tampering (such as due to prior delamination of the laminate 100) through the window 150. For example, color-changes of materials, de-metallization features, flaking, creasing, and/or other forms of irreversible damage 130 may be visible from the outside of the laminate 100 via the window 150. Markings 140 serving as security features may be visible via one or more windows 150. For example, markings 140 having inks or other materials with unique optical transmission properties may be provided in various layers and aligned within the window 150 for viewing prior to delamination of the laminate 100. These unique optical transmission properties may be difficult to counterfeit, which may further enhance the security of the laminate 100. In one particular example, one of the base layers 104, 106 (and/or other layer) may contain a thin portion of gold in alignment with the window 150. For example, the thin portion may be less than about 200 nm in thickness, which may cause the gold to appear turquoise when light is shined through the thin portion/window 150 and may serve as verification that the laminate 100 is authentic/actually contains gold. In some embodiments, the markings 140 may include feathered metal portions that provide unique optical characteristics.

In some embodiments, the markings 140 visible through the window 150 may include relief structures and/or holograms as described above. The window 150 may help focus a user's eye on the markings 140 visible therein, which may allow for quick identification of security features and may enable various optical characteristics of the hologram to be more easily recognized by the eye. Additionally, the window 150 may help optimize the metallic thickness of hologram and/or relief structure, as the window 150 may enable a portion of the hologram and/or relief structure to protrude through one or more additional layers of material. In some embodiments in which a substrate 102, 110 and/or adhesive layers (or other transparent/translucent) layer extends over or otherwise covers the window 150, the transparent/translucent material of the respective cover layer may extend over the window 150 without penetrating the opening/depth of the window 150, leaving an air gap within the laminate 100. In other embodiments, the transparent/translucent material may flow into the window 150 to fill in the void of the window 150. In such embodiments, the outer surface of the outermost layer may be planar and/or may follow a contour formed by a shape of the window 150.

In some embodiments, multiple base layers may each include a window 150 that is at least partially offset from windows 150 in other layers. For example, windows 150 may be formed in a clover design with four leaves, each formed by a different window 150 in a different layer of the laminate 100. In such embodiments, the leaves may each be translucent, with a slightly different appearance based on a depth of the layer having the window 150 that defines the respective leaf. In one particular example, each layer may be gold having a thickness of between about 50 nm and 200 nm, such that a total thickness of the base layers is between about 200 nm and 800 nm. Separate leaf-shaped windows 150 may be formed through three of the layers such that each leaf contains only one thin layer of gold. Light may pass through each leaf, making the leaf appear turquoise, while the rest of the laminate 100 appears opaque and gold. In some embodiments, a similar window arrangement may be used with four base layers of different metals. In such an embodiment, each leaf may appear to be a different color/metal. While described in relation to clover shapes, it will be appreciated that embodiments are not so limited and that various shapes formed with offset windows 150 may be formed in accordance with the present invention.

In some embodiments, windows 150 may be formed in each major surface (i.e., top and bottom) of the laminate 100 and offset from one another, which may enable a middle section of the laminate 100 (such as the base layers 104, 106, the area between the base layers 104, 106, and/or security layer 108) to be visible from either side of the laminate 100. In some embodiments, markings 140 (which may be identical or different) may be visible through both windows 150, enabling at least one marking 140 to be viewed from either major surface.

In a particular example shown in FIG. 1, the laminate 100 may have seven layers. For example, outer substrates 102 and 110 may be formed from a polymer, such as PET. A security layer 108 may be positioned between base layers 104, 106, which may be formed of copper. The security layer 108 may include security information 120 positioned within a first portion of the security layer 108 (on one or both surfaces) and markings 140 (which may include security features, identification information, and/or security information) on a second portion of the security layer 108. Intermediate base layers 112, 114 may be positioned on outer surfaces of the first base layer 104 and second base layer 106, respectively. The intermediate base layers 112, 114 may be formed from a different material than the base layers 104, 106, such as aluminum. One or more of the layers may be coupled together using an adhesive. For example, the security layer 108 may be coupled with base layers 104, 106 using an adhesive.

A window 150 may be defined in one or more of the layers to provide visual access to the markings 140, while the security information 120 is obscured on both sides by the opaque layers. For example, as illustrated the window 150 is defined in the substrate 110, intermediate layer 114, and base layer 106, which enables the markings 140 to be visible from one side of the laminate 100. To access the security information 120, the laminate 100 must be delaminated. As described above, this is typically done by peeling or otherwise separating at least one of the layers from the rest of the laminate 100. For example, in the present embodiment, the base layer 106 must be delaminated from the security layer 108 such that the security information 120 is no longer obscured by the base layer 106 (and intermediate layer 114). This delamination may cause irreversible damage 130 to one or more layers of the laminate 100 as described above.

It will be appreciated that the embodiment described above is merely representative of one of any numerous permutations of layers and designs of laminate 100 in accordance with the present invention and that variations exist. It will be further appreciated that any number of layers and/or combination of layers may be used in particular embodiments. In a simplest form, a two-layer laminate may be provided, with security information being printed on inner surfaces of one or both of the layers such that the two layers must be delaminated to reveal the security information while irreversibly damaging the laminate and/or causing one or more tamper-evident features to be activated. Other transparent, translucent, and/or opaque layers may be added to increase complexity, security, durability, aesthetics, and/or to otherwise enhance the laminate may be used in various embodiments. For example, in one embodiment, at least one decoy layer may be provided, which may contain patterns that do not exhibit security information. It will be further appreciated that while shown as having a symmetrical layout of layers, embodiments are not so limited. For example, a laminate may have a single opaque layer on a first side of the security information and multiple opaque layers on a second side of the security information.

In some embodiments, the laminates 100 described herein may be rectangular or generally rectangular in shape, however the laminate 100 may be any shape in various embodiments. In some embodiments, peripheral edges of one or both of the substrates may define the outer boundaries of the laminate 100, while in other embodiments one or more of the other layers may define the boundaries of the laminate 100. In some embodiments, all of the layers of the laminate 100 may be coextensive with one another (with the exception of any windows 150 present), while in other embodiments, one or more layers may be inward of and/or extend beyond the peripheral edges of one or more of the other layers in one or more directions. In a particular embodiment, peripheral edges of one or both of the substrates may extend beyond peripheral edges of the inner layers of the laminate 100, which may fully protect the internal layers, as well as create a transparent border (window 150) about the inner layers.

In some embodiments, the markings may include various security features including small/trace quantities of a metal (different than the metal in the base layer), embedded fibers, a dye coating (which may be fluorescent in some embodiments), a spectral-shifting coating or other treatment, particles (such as nanoparticles) having relatively unique spectral properties.

In some embodiments, the laminate 100 may include one or more textured outer surfaces. For example, one or both of the substrate layers may be applied and/or formed to include a textured surface, such as a grooved, bumpy, embossed features and/or other textured surface. In some embodiments, the base layers may be applied to form the texture of the laminate 100 such that when one or both of the substrates are affixed with the base layers, the texture of the base layer is imparted on the respective substrate.

FIG. 2 illustrates a sheet of laminates 200, according to certain embodiments. The sheet of laminates 200 may include individual laminates 202a-d, defined by borders 204a-b. The sheet of laminates 200 may include any number of laminates arranged in any number of rows and/or columns. The sheet of laminates 200 and/or some or all of the individual laminates 202a-d may include an edge protection border 206. The sheet of laminates 200 may also include registration marks 208a-b. The individual laminates 202a-d may be similar to the laminate 100 in FIG. 1A 1C. The sheet of laminates 200 (and therefore the individual laminates 202a-d) may be formed at least in part by applying one or more layers to one another to create the sheet of laminates 200.

For example, the sheet of laminates 200 may include a first transparent substrate similar to the substrate 102 in FIG. 1A. The sheet of laminates 200 may also include one or more base layers (e.g., the base layers 104 and 106), security layer(s) (e.g., the security layer 108), intermediate base layers (e.g., the intermediate base layers 112 and 114), and other such layers. The one or more layers of the sheet of laminates 200 may include similar properties and functionalities as the various layers described in FIGS. 1A-1C .

The borders 204a-b may be visible lines or other marks (as shown in FIG. 2) or may be coordinates or other means of demarking edges of and/or between the individual laminates 202a-d. For example, the borders 204a-b may be solid, dotted, and/or dashed lines created on one or more layers of the sheet of laminates 200. In another example, the borders 204a-b may include perforations or other physical demarcations indicating a border between two or more individual laminates 202a-d. In yet another example, the borders 204a-b may not have any visible or physical markings, and instead include one or more logically represented lines across some portion of the sheet of laminates 200 (e.g., abstract computer-readable instructions). The logically represented line(s) may be used by a computing device to determine a border(s) between two or more individual laminates 202a-d.

Although only two borders 204a-b are shown, any number of borders may be present (e.g., 3, 4, 10, etc.). In embodiments that include more than the two borders 204a-b, other individual laminates (in addition to or instead of the individual laminates 202a-d) may also be present on the sheet of laminates 200 (e.g., 6 individual laminates, 8 individual laminates, etc.). In some embodiments, the borders 204a-b may not include straight lines as shown in FIG. 2, but may be any shape including curved and/or angled lines. In some embodiments, the borders 204a-b may be circular, causing the individual laminates 202a-d to also be circular. One of ordinary skill in the art would recognize many different possibilities.

The edge protection pattern 206 may be created by a pattern printed on one or more of the layers of the sheet of laminates 200. For example, a transparent substrate layer (e.g., the substrate 102) may include a pattern such as the first pattern 103. The first pattern 103 may become the edge protection pattern 206. In another example, a second substrate later (e.g., the second substrate layer 110) may include another pattern such as the third pattern 123. When the sheet of laminates 200 is created (e.g., by applying the various layers to one another), the patterns on the first and second transparent substrates may combine to form the edge protection pattern 206. In yet another example, the edge protection pattern 206 may be formed on one or more of the base layers (e.g., the second pattern 113 on the base layer 104). In yet another examples, the patterns on the first and second transparent layers and the base layer(s) may combine to form the edge protection pattern 206.

The edge protection pattern 206 may be a continuous and/or discontinuous pattern that extends across some or all of the sheet of laminates 200. A continuous and/or discontinuous pattern may lead to increased efficiency in producing the various layers (and thereby the sheet of laminates 200) by simplifying a printing process or other process used to generate the edge protection pattern 206. The edge protection pattern 206 may include lines, shapes, curves, angles, patterns (e.g., a guilloche pattern) or any other suitable shape or lines. The edge protection pattern 206 may be configured such that any tampering or damage to the edge of an individual laminate 100 is visually apparent. For example, the edge protection pattern 206 may be generated using infrared ink, ultraviolet ink, or some other substance that is invisible to the naked eye under normal condition but is apparent when exposed to some environmental factor (e.g., light of a specific frequency, heat, etc.). The edge protection pattern 206 may be generated using a substance that only becomes visible when tampered with, such as an oxygen sensitive material. Tampering may also be indicated visually by interruption, removal, and/or other damage to the edge protection pattern 206 that is visible to the naked eye. Additionally, or alternatively, the edge protection pattern 206 may also be machine readable, and include a bar code, QR code, or other such code.

In some embodiments, the edge protection pattern 206 may be disposed on the sheet of laminates 200 such that each edge of the individual laminates 202a-d include the edge protection pattern 206. In other embodiments, the edge protection pattern 206 may be present on only one edge of the individual laminates 202a-d, on two edges of the individual laminates 202a-d, on three edges of the individual laminates 202a-d, etc. The edge protection pattern 206 may be substantially the same on all edges of the of the individual laminates 202a-d or may differ on any number of edges. For example, the edges corresponding to the border 204a may include a first edge protection pattern (such as a guilloche pattern), while the edges corresponding to the border 204b may include a second edge protection pattern (e.g., lines as shown in FIG. 2). Furthermore, the edge protection pattern 206 may be present across the entire sheet of laminates 200 (and therefore each of the individual laminates 202a-d), not just at the edges of the individual laminates 202a-d and/or the borders 204a-b.

The edge protection pattern 206 may be formed by applying ink, other pigments, release material and/or adhesive material to one or more of the various layers of the sheet of laminates 200. The edge protection pattern 206 may be on only one side of the individual laminates, or on both sides of the individual laminates. Additionally, or alternatively, the edge protection pattern 206 may be formed by magnetic ink or pigment, by electrically charged material, by chemically altered material, and/or using other techniques. In some embodiments, the edge protection pattern 206 may be applied using an ultraviolet (UV)-sensitive ink (e.g., via invisible printing), an oxidizing material (as described above), or other such material. The edge protection pattern 206 may be invisible unless subjected to certain environmental conditions (e.g., light of a particular wavelength, heat, a gas, etc.). Thus, if an individual laminate 202a-d is tampered with or otherwise altered, some or all of the edge protection pattern 206 may be altered indicating damage and/or tampering.

In some embodiments, the edge protection pattern 206 may include a relief structure, applied to a given layer using one or more techniques. For example, cavities of the relief structure may be created within a given layer's surface by heat application, melting, scratching, cutting, impacting, embossing, denting, blistering, surface relief casting, reticulation, bi-phase separation deposition, mud cracking (e.g., random cracking of a polymer layer), laser ablation, etching including plasma, laser, ion beam, electron beam, chemical, bead blasting, sand blasting, and/or other techniques. In embodiments in which multiple cavities are created, each cavity may be created the same or different technique. Protrusions of the relief structure may be created by placing pigmented ink, placing a transparent material, spraying material, printing material, placing material by adhesion, molding, painting, lamination, blistering, surface relief casting, reticulation, bi-phase separation, deposition, sintering, selective chemical vapor deposition, electroless plating, electroplating, low energy cauliflower growth deposition, and/or other deposition techniques. In embodiments in which multiple protrusions are created, each protrusion may be created the same or different technique.

The registration marks 208a-b may be formed by assigning a feature of the edge protection pattern 206 and/or a feature of a pattern included on any of the various layers of the sheet of laminates 200 (e.g., the first pattern 103, second pattern 113, third pattern 123, etc.) as a registration mark. The registration marks 208a-b may be machine readable (e.g., as shown in FIG. 2.). The registration marks 208a-b may be different than the edge protection pattern 206. For example, if the edge protection pattern 206 includes a guilloche pattern, the registration marks 208a-b may include a shape different than other shapes included in the guilloche pattern. Additionally, or alternatively, the registration marks 208a-b may include a space in the edge protection pattern 206 that is different than the rest of the edge protection pattern 206 (e.g., a void where there should be a shape in a guilloche pattern). In other embodiments, the registration marks 208a-b may be a regularly occurring feature of the edge protection pattern 206. For example, the edge protection pattern 206 may include a regular pattern of dots (or some other image). Coordinates (relative to an individual laminate 202a-d) may be determined that corresponds with a particular dot of the pattern of dots. The particular dot may then be assigned as a registration mark. The coordinates may be determined within a tolerance of about 1 μm, 5 μm, 1 mm, etc.

The registration marks 208a-b may be present on one or more locations on the sheet of laminates 200. For example, the registrations marks 208a-b may be disposed at opposite corners where the borders 204a-b meet (as shown in FIG. 2). In other embodiments, a registration mark may only be present where the borders 204a-b meet. In still other embodiments, the registration marks 208a-b may be disposed at regular intervals along one or more of the borders 204a-b. The registration marks 208a-b may be machine readable and/or identifiable using a laser sensor, a camera, other optical sensors, or any other appropriate sensor. The registration marks 208a-b may be used (after being identified) by a cutting apparatus to cut the individual laminates 202a-d from each other and/or the sheet of laminates 200. As shown in FIG. 2, the registration marks 208a-b may be present on some or all of the individual laminates 202a-d. In other words, once the individual laminates 202a-d are cut from the sheet of laminates 200, each laminate 202a-d may include a respective registration mark. The registration marks 208a-b may be located such that the cutting apparatus cuts the sheet of laminates 200 along the borders 204a-b within a predetermined threshold to separate the individual laminates 202a-d. The predetermined threshold may be within a range of 5 μm to 5 mm, inclusive. For example, the predetermined threshold may be 1 mm, 2 mm, etc. By assigning the registration marks 208a-b such that the sheet of laminates 200 are cut within the predetermined threshold, features of the edge protection pattern 206 may be created such that tampering or other damage is readily apparent. One or more of the registration marks 208a-b may form part of the final cut laminate and/or may be trimmed/omitted from the final cut laminate.

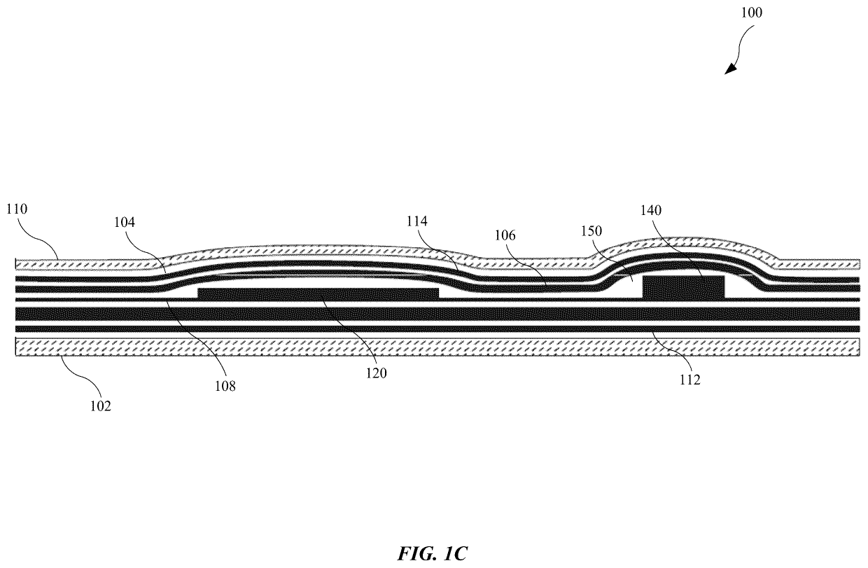

FIG. 3 illustrates a sheet of laminates 300, according to certain embodiments. The sheet of laminates 300 may include individual laminates 302a-d defined by borders 304a-d. The sheet of laminates 300 (and/or the individual laminates 302a-d) may include an edge protection pattern 306 and registration marks 308a-h. The sheet of laminates 300 may be similar to the sheet of laminates 200 in FIG. 2. For example, the sheet of laminates 300 may include a plurality of layers such as transparent substrates, base layers, security layers etc. as described in relation to FIGS. 1A-C and FIG. 2. The sheet of laminates 300 may therefore share similar properties and functionalities as the sheet of laminates 200.

The borders 304a-d may define (at least in part) each of the individual laminates 302a-d. The borders 304a-d may be visible lines or other marks (as shown in FIG. 3) or may be coordinates or other means of demarking edges of and/or between the individual laminates 302a-d. For example, the borders 304a-d may be solid, dotted, and/or dashed lines created on one or more layers of the sheet of laminates 300. In another example, the borders 304a-b may include perforations or other physical demarcations indicating a border between two or more individual laminates 302a-d. In yet another example, the borders 304a-b may not have any visible or physical markings, and instead be a logically represented line(s) across some portion of the sheet of laminates 300. The logically represented line(s) may be used by a computing device to determine a border(s) between two or more individual laminates 302a-d.

Although only four borders 304a-d are shown, any number of borders may be present (e.g., 3, 4, 10, etc.). In embodiments that include more than the four borders 304a-d, other individual laminates (in addition to or instead of the individual laminates 302a-d) may also be present on the sheet of laminates 300 (e.g., 6 individual laminates, 8 individual laminates, etc.). In some embodiments, the borders 304a-d may not include straight lines as shown in FIG. 3 but may be any shape including curved and/or angled lines. In some embodiments, the borders 304a-d may be circular, causing the individual laminates 302a-d to also be circular. One of ordinary skill in the art would recognize many different possibilities.

In contrast to the borders 204a-b in FIG. 2, the borders 304a-d may define a space of the sheet of laminates 300 that is not included in the individual laminates 302a-d. For example, the borders 304a and 304b may define a length of the individual laminates 302a-d, whereas a similar length of the individual laminates 302a-d may be defined by just the border 204b. The borders 304a-b may be separated by a first distance such as 1 mm, 2 mm, 3 mm, 4 mm, 5 mm, 6 mm, 7 mm, etc. Similarly, the borders 304c-d may define a width of the individual laminates 302a-d. The borders 304c-d may be separated by a second distance. The second distance may be equal to the first distance or may be some other distance.

The edge protection pattern 306 may include one or more shapes located at regular intervals across the sheet of laminates 300. As shown in FIG. 3, the edge protection pattern 306 may be located such that each of the one or more shapes of the edge protection pattern 306 are at or near a particular border 304a-d, corner, and/or an edge of the sheet of laminates 300. When the sheet of laminates is cut (as is described in relation to FIG. 2), the edge protection pattern 306 may be at or near some or all of the edges of each individual laminate of the individual laminates 302a-d. If an edge of an individual laminate is subsequently tampered with, one or more of the shapes of the edge protection pattern 306 may appear incorrect. For example, as shown in FIG. 3, the one or more shapes may be a series of circles. If an edge of an individual laminate was trimmed, some or all of the circles along the edge may appear incomplete, indicating tampering.

Accurate and precise cutting along the borders 304a-d may enable the edge protection pattern 306 to be more effective. For example, if the sheet of laminates 300 was cut to a tolerance of 1 cm, the one or more shapes of the edge protection pattern 306 may be up to 1 cm away from the edge of the individual laminate. If the individual laminate was then trimmed along the edge (e.g., a 1 mm strip), the one or more shapes of the edge protection pattern 306 may be unaltered. Furthermore, the tampering may go unnoticed, as the amount trimmed may be a small percentage of the laminate available between the edge of the individual laminate and the edge protection pattern 306.

The registration marks 308a-h may be located on the sheet of laminates 300 to help achieve the accuracy and precision desired. Whereas in FIG. 2 the registration marks 208a-b may be included in the edge protection pattern 206, the registration marks 308a-h may be separate from the edge protection pattern 306. The registration marks 308a-h may be located within the area defined between two parallel borders. For example, the registration marks 308a-f may be disposed between the borders 304a-b and the registration marks 308g-h may be disposed between the borders 304c-d. The registration marks 308a-h may be aligned with the edge protection pattern 306 or may be aligned separately. The registration marks 308a-h may be spaced at regular intervals along one or more axes of the sheet of laminates 300. The registration marks 308a-h may be located at respective positions within a tolerance of about 1 μm, 5 μm, 1 mm, etc.

The registration marks 308a-h may be machine readable and/or identifiable using a laser sensor, a camera, or any other appropriate sensor. The registration marks 308a-h may be any shape (e.g., circular, square, triangular, etc.) or may be a series of lines or other markings. The registration marks 308a-h may be identical or may include multiple forms. The registration marks 308a-h. may be used (after being identified) by a cutting apparatus to align the sheet of laminates 300 with a cutting implement and to cut the individual laminates 302a-d from each other and/or the sheet of laminates 300, as is described in relation to FIG. 2. Some or all of the registration marks 308a-h may form a portion of one or more of the final cut laminates and/or may be removed entirely.

FIG. 4A illustrates a first layer 402 with a first pattern 403, according to certain embodiments. FIG. 4B illustrates a second layer 404 with a second pattern 413, according to certain embodiments. FIG. 4C illustrates a laminate 400 with an edge protection pattern 406, according to certain embodiments. The first layer 402 may be a transparent substrate similar to the substrate 102 in FIG. 1A and have similar properties and functionalities. The first layer 402 may include the first pattern 403. Although the first pattern 403 is shown as a simple pattern of lines, it should be understood that the first pattern 403 may be any pattern including geometric designs and patterns (e.g., a guilloche pattern), images, etc.

The second layer 404 may be a transparent substrate and be similar to the second substrate 110 in FIG. 1A including similar properties and functionalities. The second layer 404 may include the second pattern 413. The second pattern 413 may be correlated to the first pattern 403. For example, as shown in FIG. 4B, the second pattern 413 may be similar to the first pattern 403 but rotated 90° (or at some other angle). In other embodiments, the second pattern 413 may be unrelated to the first pattern 403.

The laminate 400 may be similar to the laminate 100 in FIGS. 1A-C and include similar properties and functionalities. For example, the laminate 400 may include one or more base layers (e.g., the base layers 104 and 106), security layers (e.g., the security layer 108), and other layers as described in relation to FIGS. 1A-C. As shown in FIG. 4C, portions of the first layer 402 and the second layer 404 may be visible in the finished laminate 400. In other words, the transparent first and second layers 402-404 may extend beyond any opaque layers included in the laminate 400 (e.g., a metallic base layer). Thus, when the laminate 400 is produced, the first pattern 403 and the second pattern 413 may combine to form the edge protection pattern 406. Although the first pattern 403, the second pattern 413, and the edge protection pattern 406 may be relatively simple as shown, it should be understood that any patterns, images, etc. may be present. For example, the first pattern 403 may include a pattern of semi-circles and/or other lines. The second pattern 413 may then include a corresponding pattern of semi-circles and/or other lines, but opposite (or reverse) of the first pattern 403. Then, the laminate 400 may include a repeating pattern of closed shapes (e.g., a guilloche pattern) as the edge protection pattern 406. In another embodiment, the first pattern 403 may include a left side of an image spanning a width of the first layer 402. The second pattern 413 may then include a right side of the image spanning a width of the second layer 404. The edge protection pattern 406 may then include the full image spanning the width of the laminate 400. In other embodiments, the edge protection pattern 406 may include colors instead of or in addition to shapes, lines, etc. For example, the first pattern 403 may include a blue color, the second pattern 413 may include a yellow color, and then the edge protection pattern 406 may include a green color. In some embodiments, one or more portions of the edge protection pattern 406 may be invisible to the naked eye. One of ordinary skill in the art would recognize many different possibilities and configurations.

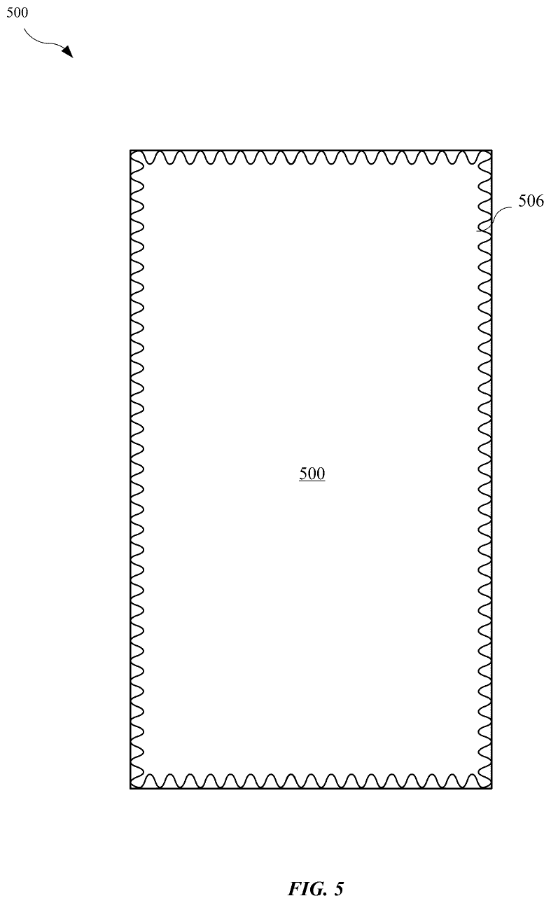

FIG. 5 illustrates a laminate 500 with an edge protection pattern 506, according to certain embodiments. The laminate 500 may be similar to the laminate 100 in FIG. 1A and include similar properties and functionalities. The laminate 500 may be one individual laminate cut from a sheet of laminates similar to the sheet of laminates 200 in FIG. 2. The laminate 500 may include the edge protection pattern 506. The edge protection pattern 506 may be a continuous and/or discontinuous pattern that extends beyond the laminate 500 to an adjacent individual laminate (before being cut from the sheet of laminates). The edge protection pattern 506 may include a regular pattern such as sine wave-type pattern and/or other undulating pattern, as shown in FIG. 5. The edge protection pattern 506 may be disposed on all sides of the laminate 500, or may be disposed on one side, two sides, or three sides, etc.

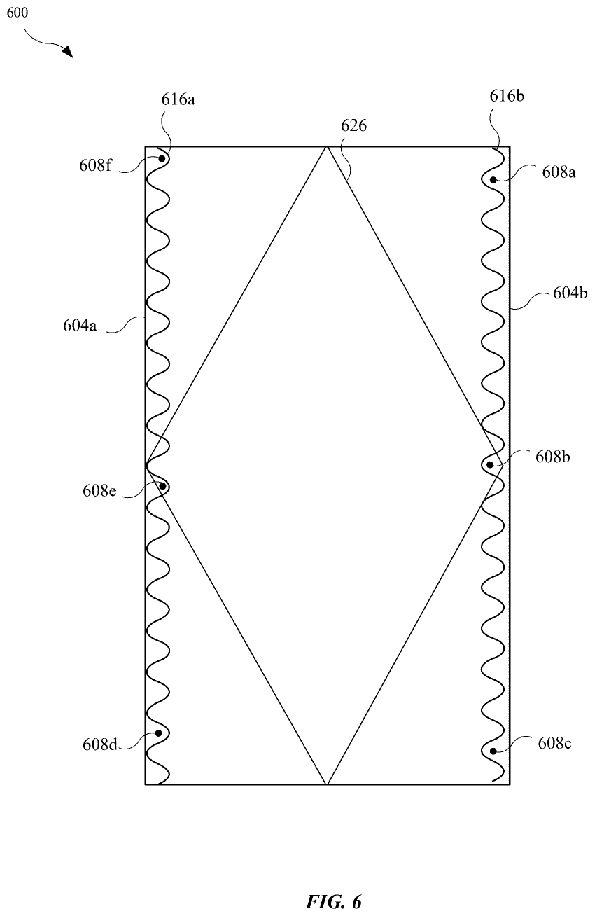

FIG. 6 illustrates a laminate 600 with an edge protection pattern 606, according to certain embodiments. The laminate 600 may be similar to the laminate 100 and/or 500 in FIGS. 1A and 5, respectively, and include similar properties and functionalities. The laminate 600 may include edges 604a-b. Some or all of the edge protection pattern 506 may be present on two sides of the laminate 600 as shown (e.g., the edges 604a-b), or may be present on three sides, four sides, etc., and include registration marks 608a-f. The registration marks 604a-f may be similar to the registration marks 208a-b and include similar properties and functionalities.

The edge protection pattern may include a line 616 and a diamond 626. The line 616 and/or the diamond 626 may be part of a continuous and/or discontinuous pattern present on a sheet of laminates (e.g., the sheet of laminates 300 in FIG. 3). Thus, an adjacent individual laminate from the sheet of laminates may include the edge protection pattern 606. For example, a laminate on the sheet of laminates adjacent to the edge 604b may include a line similar to the line 616. The line may include peaks and troughs that substantially follow the line 616b or may include peaks and troughs opposite that of the line 616b.

The laminate 600 may be cut from the sheet of laminates according to a predetermined threshold or tolerance. For example, the predetermined threshold may be about 0.1 mm, about 0.2 mm, about 0.3 mm, about 0.4 mm, about 0.5 mm, about 0.75 mm, about 1 mm, about 2 mm, about 3 mm, etc. the laminate 60 may be cut to within about 95% of the predetermined threshold, about 97% of the predetermined threshold, about 99% of the predetermined threshold, about 99.5 % of the predetermined threshold, etc. Thus, when the laminate 600 is cut from the sheet of laminates, there may be a gap between some or all of the edge protection pattern 606 and the edges 604a-b of the laminate 600. As shown in FIG. 6, the line 616a may meet the edge 604a. Similarly, an apex of the diamond 626 may reach the edge 604a. Thus, if the edge 604a is tampered with and/or damaged, the line 616a may no longer appear continuous and/or discontinuous along the edge 604a. Similarly, the apex of the diamond 626 may no longer be present along the edge 604a. Tampering may thereby be readily apparent. In some embodiments, a thickness of all or a portion of one or more of the edge protection patterns may have a thickness that matches the tolerance such that is a thickness of the portion of the pattern is reduced, it may be determined that edge tampering has occurred.

By contrast, the edge 604b may be cut from the sheet of laminates within the tolerance, but such that the line 616b does not reach the edge 604b. Similarly, the apex of the diamond 626 may not reach the apex of the edge 604b. If the tolerance is 1 mm, for example, the distance from the edge 604b to the edge protection pattern 606 (e.g., the line 616b and/or an apex of the diamond 626) may be 1 mm or less. Therefore, the laminate 600 may still be valid. Furthermore, the area of the laminate 600 between the edge 604b and the line 616b and/or the diamond 626 may be so small as to deter tampering based on the cost/benefit of trimming a small portion of the laminate 600. If, by contrast, the laminate 600 was within tolerance in the other direction (i.e., towards the center of the laminate 600), the laminate 600 may no longer be valid, as the edge protection pattern 606 may no longer indicate tampering reliably.

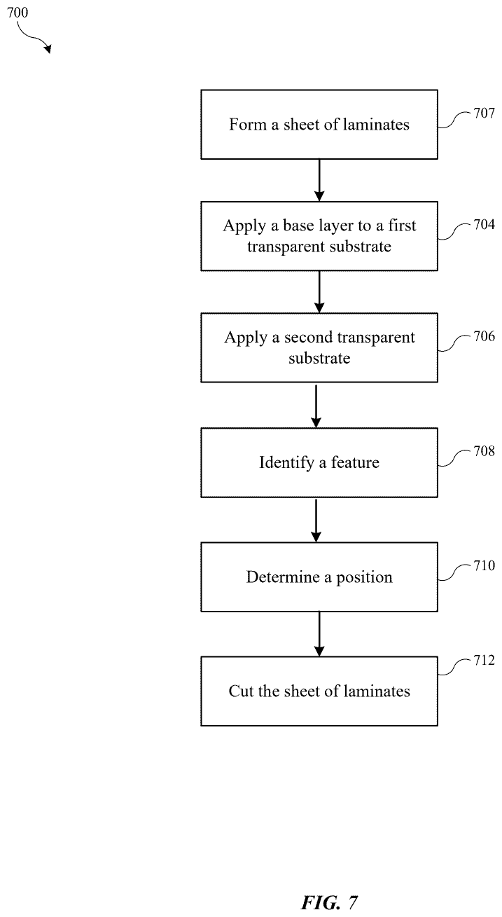

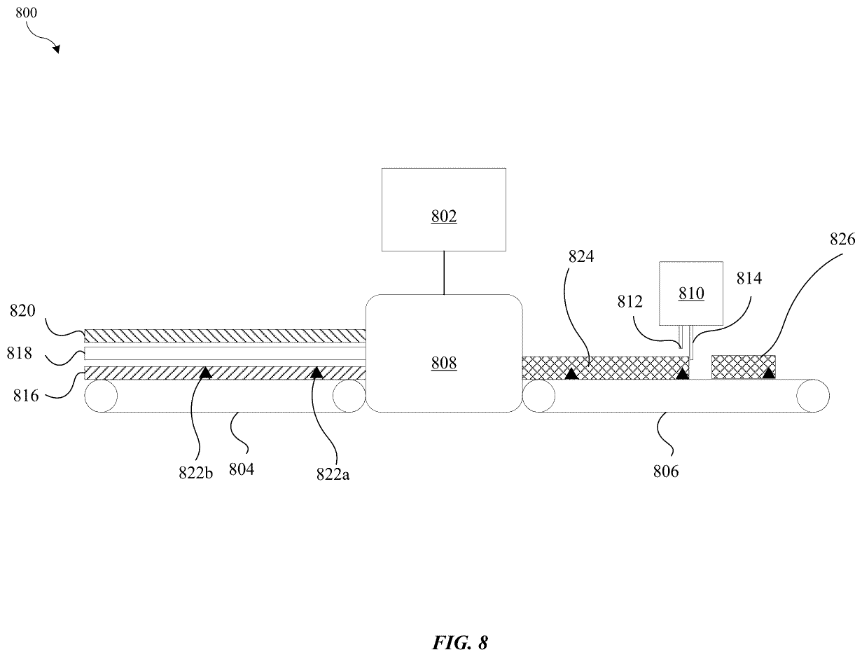

FIG. 7 illustrates a flowchart of a method 700 for producing a laminate 826 (which may be similar to and include any features described in relation to the laminates described elsewhere herein), according to certain embodiments. FIG. 8 illustrates an apparatus 800 for producing a laminate, according to certain embodiments. FIG. 8 is described in relation to FIG. 7 and vice a versa. The method 700 may be performed by the systems and devices described herein (e.g., the apparatus 800). Some of the steps of the method 700 may be performed in a different order than is described and/or may be combined with other steps. In some embodiments, some steps may be skipped altogether. The apparatus 800 may include a controller 802, rollers (or other transport mechanisms and/or conveyors) 804 and 806, a lamination module 808, and a cutting apparatus 810. The cutting apparatus may include a sensor 812 and a cutting implement 814. The controller 802 may be configured to transmit instructions to perform some or all of the method 700 to one or more components of the apparatus 800 according to computer readable instructions. The controller 802 may receive the computer readable instructions via WiFi, floppy disk, flash drive, or any other suitable method.

The roller 804 may be configured to accept one or more layers used to form a sheet of laminates 824. Although only one roller 804 is shown, it should be understood that any number of rollers and/or other transport mechanisms may be present. For example, each layer used to form the sheet of laminates 824 may have a dedicated roller. The roller 804 may feed the one or more layers to the lamination module 808. The lamination module 808 may affix the one or more layers to one another to produce the sheet of laminates 824. The roller 806 may then accept the sheet of laminates 824 from the lamination module 808 and support the sheet of laminates 824 during a cutting procedure.

At step 702, the method 700 may include forming the sheet of laminates 824. The sheet of laminates 824 may be similar to the sheet of laminates 200 in FIG. 2 and/or the sheet of laminates 300 in FIG. 3. Thus, the sheet of laminates 824 produced by the method 700 may include similar properties and functionalities.

To form the sheet of laminates 824, at step 704, the method 700 may include applying a base layer 818 on a first transparent substrate 816. The first transparent substrate 816 may be similar to the substrate 102 in FIG. 1A. The first transparent substrate 816 may include a first pattern (e.g., the first pattern 103 in FIG. 1 and/or the first pattern 403 in FIG. 4). At least a portion of the first pattern may define one or more boundaries of the laminate 826. The laminate 826 may be similar to the laminate 100, the laminate 400, and or the individual laminates 202a-d and 304a-d. The base layer 818 may include at least one precious and/or non-precious metal. In some embodiments, the base layer 818 may be applied using sputter deposition, such as ion-beam sputtering, reactive sputtering, ion-assisted deposition, high-target-utilization sputtering, high-power impulse magnetron sputtering, and/or gas flow sputtering. In some embodiments, the base layer 818 may be applied via electroplating, colloidal deposition (and subsequent removal of a colloidal suspension liquid via application of heat and/or vacuum and/or densification by heat and/or pressure), adhesive lamination of metallic leaf, physical-vapor deposition, atomic layering, vacuum deposition, and/or other deposition process.

In some embodiments, depositing the base layer 818 may include applying a number of sublayers of the precious metal atop the first transparent substrate 816. For example, the metal may be applied using a number of deposition steps that may enable greater control and precision of the amount and pattern of metal provided within the sheet of laminates 824. In some embodiments, the sublayers may all be applied using a single type of deposition process, while in other embodiments, multiple types of deposition processes may be used to deposit the sublayers. For example, the first sublayers may be deposited using a first method, while the final sublayers are deposited using a second method, which, in some embodiments, may be a more precise deposition method than the first. As just one example, the first sublayers may be deposited using evaporative deposition, while the final sublayers are deposited using sputtering. In some embodiments, each of the sublayers may have a same shape and/or thickness, while in other embodiments one or more of the sublayers may have different shapes and/or thicknesses. For example, in some embodiments, earlier-applied sublayers (closer to the substrate and/or transition layer) may be thicker than one of more of the last-applied sublayers. This may be particularly advantageous as it allows a bulk of the precious metal to be deposited rather quickly, with the last portion of the precious metal to be carefully deposited to provide a precious amount of total precious metal within the laminate. Additionally, the use of thinner sublayer passes when depositing thicker base layers, as depositing thicker sublayers may cause melting and/or over-depositing. For example, prior to depositing the last sublayer (or multiple last sublayers), measuring a total thickness of previous sublayers to determine a thickness of the last sublayer (or number of last sublayers). For example, the final sublayer thickness may be based on a difference between the measured thickness of the previous sublayers and a desired total thickness of the base layer. The last sublayer (or multiple last sublayers) may then be deposited at the desired thickness. In some embodiments, rather than measuring the previous sublayers, the deposition process may be predefined to deposit a number of sublayers of a desired thickness (constant and/or variable) and/or shape to achieve a base layer of a desired shape and/or thickness. The shape and/or thickness of each of the sublayers may be the same or different. In some embodiments, one of more of the sublayers may be non-planar. In such embodiments, the last sublayer may be applied with variable thickness to produce a generally planar base layer. In other embodiments, the last sublayer may be applied with a flat and/or variable thickness to produce a non-planar base layer. In some embodiments, to adjust the thickness and/or profile shape of a sublayer, a speed of a cathode (or other deposition tool) and/or power supplied to the deposition tool may be altered.

In some embodiments, the sublayers may have a tapered and/or curved profile across a width and/or length of the sublayers as described herein. For example, one or more of the sublayers may have a first profile in a machine direction (e.g., the apparatus 800) and a second profile in a cross-machine direction. As just one example, one or more of the sublayers may have a tapered profile in the machine direction, while one or more of the sublayers may have a concave and/or convex profile in the cross-machine direction. It will be appreciated that any shape and/or combination of shapes of profiles may be provided in one or more sublayer of the base layer. Each outer surface of the base layer may have a same or different surface finish and/or texture which may be applied before and/or after the base layer is applied to the first transparent substrate 816.

In some embodiments, one or more intervening layers may be applied between the base layer 818 and the first transparent substrate 816. For example, a transition layer containing a transition metal, such as an oxide and/or carbide, may be deposited and/or otherwise applied to the first transparent substrate 816 prior to applying the base layer 818. For example, the transition layer may be sputtered, deposited via evaporation, ion plated, chemical vapor deposited, and/or otherwise applied to the first transparent substrate 816. This may be particularly useful when the base layer 818 includes a precious metal, such as gold, which may be more difficult to adhere to the first transparent substrate 816. The first transparent substrate 816 may be formed of a polymer. In some embodiments, prior to applying the transition layer to the first transparent substrate 816, the first transparent substrate 816 may be processed and/or otherwise prepared to increase the adhesion between the first transparent substrate 816 and subsequently-applied layers (e.g., the base layer 818).

For example, the processing steps may include removing a portion of the first transparent substrate 816, removing hydrogen atoms from the first transparent substrate 816 via dehydrogenation, cleaning the first transparent substrate 816, and/or removing oligomers from the first transparent substrate 816. In some embodiments, the first transparent substrate 816 may be corona treated to increase adhesion. In some embodiments, alternatively, or in addition to the transition layer, one or more intermediate base layers may be deposited on the first transparent substrate 816 prior to depositing the base layer 818. The intermediate layers may be the same or different than the base layer 818 and may be applied using the same or different techniques.

In some embodiments, the method 700 may also include feathering a portion of the base layer 818. This feathering may create thinner areas within the base layer 818 and/or otherwise create areas with unique optical properties, which may be used as security features that can be used to verify the authenticity of the laminate 826. The feathered areas may have an optical density of between about 1 and 4 and may be translucent and/or reflective. In some embodiments, the feathering may be done by first spraying and/or otherwise applying a substance (such as oil and/or ink) on a portion of the first transparent substrate 816. In some embodiments, the substance may be selected to evaporate in vacuum. As the base layer 818 is deposited on the first transparent substrate 816, feathered shadows may be created at locations of the substance. In some embodiments, feathering may be applied by placing a heat-resistant object between a sputtering target and the first transparent substrate 816 and then sputtering the base layer onto the first transparent substrate 816, which may cause feathering in the form of a shadow. In some embodiments, the heat-resistant object may be moved in a predetermined and/or random pattern, which may cause the shadowing/feathering to vary based on the movement of the heat-resistant object. In some embodiments, the moving object may move at a constant rate, which may result in a shadow of generally uniform appearance/thickness. In other embodiments, the moving object may move at a variable rate and/or pause at one or more locations, which may result in a shadow of variable thickness and/or otherwise non-uniform shadow. In some embodiments, the feathering may be created by mechanically scratching, chemically etching, and/or laser etching a portion of the base layer 818 and/or one or more sublayers.

In some embodiments, the deposition process may create a feathered and/or otherwise thinned portion without the use of other substances. For example, the deposition process may involve depositing a thinner portion of precious metal on one or more areas (which may extend through one or more sublayers), creating a gap in one or more sublayers, and/or otherwise depositing the precious metal in a manner in which a thinned or feathered portion if provided. In some embodiments, the feathered area may be a random shape or pattern, while in other embodiments, the feathered area may be a predefined shape and/or textual message, such as a clover such as described above. In some embodiments, the feathered portion may be in only one sublayer and/or a subset of sublayers of the base layer 818. In some embodiments, in which the feathered portion is formed in only some of the sublayers, masking steps using inks, oils, heat-resistant objects, etc., may be performed by placing such materials on the substrate and/or on one of more previously applied sublayers. For example, the masking steps may include applying a masking agent (such as a layer of oil, ink, and/or other heat-resistant material that may or may not be printable) atop areas in which no removal of material is desired. Portions of the sublayers and/or first transparent substrate 816 that remain exposed (e.g., are uncovered by the masking agent) may be etched and/or otherwise removed, while the masked regions remain unchanged. The masking agent may be later removed through evaporation, by peeling, and/or other technique to expose the underlying first transparent substrate 816 and/or sublayers. In some embodiments, a thickness of the feathered portion may be less than about 200 nm, while a thickness of the remaining portion of the base layer is greater than about 200 nm. In some embodiments, a thickness of the feathered portion may vary across an area of the laminate 826 so as to create a gradient of metal, which may be translucent across all or a portion of the gradient to provide variable optical properties across the gradient.

The first pattern on the first transparent substrate 816 may be formed by applying ink, other pigments, release material and/or adhesive material to the first transparent substrate 816, by magnetic ink or pigment, by electrically charged material, by chemically altered material, and/or using other techniques. In some embodiments, the first pattern may be applied using an ultraviolet (UV)-sensitive ink, an oxidizing material, or other such material. Thus, if the laminate 826 is tampered with or otherwise altered, some or all of the first pattern may be altered indicating damage and/or tampering.

The first pattern may be a continuous and/or discontinuous pattern along an edge of the laminate 826 (e.g., as shown in FIG. 6). In other embodiments, the first pattern may include figures, lines, shapes, etc. along only a portion of the edge. In some embodiments, the first pattern may be formed along multiple edges of the laminate 826. At least a portion of the first pattern may form the registration marks 822a-b. The registration marks 822a-b may be machine readable registration marks. The registration marks 822a-b may be used by the cutting apparatus 810 to identify a position of the cutting apparatus 810 in relation to the sheet of laminates 824. The sensor 812 of the cutting apparatus may include a laser, optical reader, or other suitable sensor capable of identifying the registration marks 822a-b on the sheet of laminates 824. In some embodiments, the base layer 818 may include a third pattern, as described in relation to the second pattern 113 in FIG. 1A.

At step 706, the method 700 apply a second transparent substrate 820. The second substrate 820 may be similar to the substrate 110 in FIG. 1A and include similar properties and functionalities. The second substrate 820 may include a second pattern (e.g., the second pattern 413 in FIG. 4). The second pattern on the second transparent substrate 820 may be formed by applying ink, other pigments, release material and/or adhesive material to the second transparent substrate 820, by magnetic ink or pigment, by electrically charged material, by chemically altered material, and/or using other techniques. In some embodiments, the second pattern may be applied using an ultraviolet (UV)-sensitive ink, an oxidizing material, or other such material. Thus, if the laminate 826 is tampered with or otherwise altered, some or all of the second pattern may be altered indicating damage and/or tampering.

The second transparent substrate 820 may be identical to the first transparent substrate 816 in some embodiments, while in other embodiments, the second transparent substrate 820 may be formed from a different material, a different color, a different thickness, and/or have other distinct properties. In a particular embodiment, the second transparent substrate 820 may be formed from a protective lacquer that is applied over the inner layers of the laminate 826. In some embodiments, the second transparent substrate 820 may be applied directly to the base layer 818. In other embodiments, a second transition layer and/or one or more intermediate metallic (or otherwise opaque) layers may be disposed between the base layer 818 and the second transparent substrate 820. In some embodiments, prior to applying the second transparent substrate 820, the second transparent substrate 820 may be processed and/or otherwise prepared to increase the adhesion between the second substrate and the previously-applied layers. For example, the processing steps may include removing a portion of the second transparent substrate 820, removing hydrogen atoms from the second transparent substrate 820 via dehydrogenation, cleaning the second substrate, and/or burning off oligomers from the second transparent substrate 820. In some embodiments, the second transparent substrate 820 may be applied to the second transition layer, intermediate base layer, and/or the base layer 818 using adhesive lamination. In embodiments in which the base layer 818 is textured, feathered, and/or otherwise has a variable thickness, the second transparent substrate 820 may be applied with a constant thickness, which may result in the texture and/or other contour being passed through to the second transparent substrate 820 (and subsequently, the laminate 826). In other embodiments, the second transparent substrate 820 may be applied with a variable thickness so as to fill in voids formed by the texture and/or profile of the base layer and impart a planar outer surface to the second transparent substrate 820 and laminate 826.

The first pattern, second pattern, and/or the third pattern may be any pattern including geometric designs and patterns (e.g., a guilloche pattern), images, etc. The second pattern may be correlated to the first pattern. For example, as shown in FIG. 4B, the second pattern may be similar to the first pattern but rotated 90°. In other embodiments, the second pattern may be unrelated to the first pattern.

When the laminate 826 is produced, the first pattern and the second pattern may combine to form an edge protection pattern. Although the first pattern, the second pattern, and the edge protection pattern may be relatively simple as shown, it should be understood that any patterns, images, etc. may be present. For example, the first pattern may include a pattern of semi-circles and/or other lines. The second pattern may then include a corresponding pattern of semi-circles and/or other lines, but opposite (or reverse) of the first pattern. Then, the laminate 826 may include a repeating pattern of closed shapes (e.g., a guilloche pattern) as the edge protection pattern. In another embodiment, the first pattern may include a left side of an image spanning a width of the first transparent substrate 816. The second pattern may then include a right side of the image spanning a width of the second transparent 820. The edge protection pattern may then include the full image spanning the width of the laminate 826. In other embodiments, the edge protection pattern may include colors instead of or in addition to shapes, lines, etc. For example, the first pattern may include a blue color, the second pattern may include a yellow color, and then the edge protection pattern may include a green color. One of ordinary skill in the art would recognize many different possibilities and configurations.

After the sheet of laminates 824 is produced (e.g., exits the lamination module 808 via the roller 806), at step 708, the method 700 may include identifying at least one feature from the first pattern, the second pattern, and/or the edge protection pattern, (collectively, “patterns”) as the registration marks 822a-b. For example, if the patterns include a guilloche pattern, the registration marks 822a-b may include a shape different than other shapes included in the guilloche pattern. Additionally, or alternatively, the registration marks 822a-b may include a space in the pattern(s) that is different than the rest of the pattern(s) (e.g., a void where there should be a shape in a guilloche pattern) and/or may be entirely separate from the patterns. In other embodiments, the registration marks 822a-b may be a regularly occurring feature of the pattern(s). For example, the pattern(s) may include a regular pattern of dots (or some other image). Coordinates (relative to the sheet of laminates 824 and/or the laminate 826) may be determined that corresponds with a particular dot of the pattern of dots. The particular dot may then be assigned as a registration mark. The coordinates (and therefor the registration marks 822a-b) may be determined within a tolerance of about 1 μm, 5 μm, 1 mm, etc.

At step 710, the method 700 may include determining a position of the cutting apparatus 810 relative to the sheet of laminates 824 based at least in part on the registration marks 822a-b. For example, the sensor 812 of the cutting apparatus 810 may detect a registration mark (e.g., registration marks 822a-b) on the sheet of laminates 824. The cutting apparatus 810 may then determine and/or adjust a position of the cutting apparatus 810 and/or the cutting implement 814 in relation to the sheet of laminates 824. The cutting implement 814 may include a laser cutter, cutting blade, and/or other device that can cut out the individual laminates.

At step 712, the method 700 may include cutting the sheet of laminates 824 according to the position of the cutting apparatus 810 relative to the registration marks 822a-b such that the one or more boundaries of the laminate 826 are within a predetermined threshold. The predetermined threshold (or tolerance) may be within a range of 5 mm to 3 mm, inclusive. The cutting apparatus 810 may cut the sheet of laminates 824 using the cutting implement 814 to produce the laminate 826. After identifying the registration marks 822a-b, the cutting implement 814 may cut or otherwise divide the sheet of laminates 824 to produce the laminate 826. The registration marks 822a-b may allow the laminate 826 to be produced within a tolerance of about 0.5 mm, about 1 mm, about 2 mm, about 3 mm, etc. For example, the length and width of the laminate 826 may be associated with respective desired measurements (e.g., the desired length may be 20 mm). The registration marks 822a-b may therefore allow the length of the laminate 826 to be cut within a range of 19 mm to 21 mm, inclusive. The laminate 826 may be cut to within about 95% of the desired measurements, about 97% of the desired measurements, about 99% of the desired measurements etc. One of ordinary skill in the art would recognize many different possibilities and configurations.

In some embodiments, the method 700 may include determining that the one or more boundaries of the laminate 826 are within the tolerances. For example, a laser measuring system may be included in the system 800. The laser measuring system may determine one or more dimensions and/or design element features (e.g., size and/or position of one or more edge protection features) of the laminate 826. The one or more dimensions and/or design element features may then be compared to an expected set of dimensions (e.g., the one or more boundaries) and/or design element features. If the one or more dimensions and/or design element features of the laminate are within a tolerance, the laminate 826 may be approved. The tolerance may be within 90% of the expected set of dimensions and/or design element features, about 95% of the expected set of dimensions and/or design element features, about 97% of the expected set of dimensions and/or design element features, about 99% of the expected set of dimensions and/or design element features.

In some embodiments a second base layer may be deposited on the base layer 818 (directly or with one or more intervening layers). In some embodiments, the second base layer may be formed from the same metal and/or a different metal than the base layer 818. The second base layer may include one or more precious and/or non-precious metals. In some embodiments, an outer surface (facing away from the first base layer) of the second base layer may have a same or different surface finish and/or texture as an outer surface of the first base layer.

In some embodiments, one or more security features may be provided between the base layer 818 and the second base layer. For example, the security features may be formed on and/or otherwise provided on inner surfaces of one or both base layers and/or be provided as separate layers, such as a security layer. In some embodiments, no adhesive is applied directly over the security data. These security features may include security information (such as security information 120), markings (such as markings 140, including anti-counterfeiting and/or tamper-resistant/evident features), and/or other security features. For example, various processing may be performed on one or more of the layers of the laminate 826 to produce various optical effects that may serve as markings, aesthetic features, and/or security features. As just one example, a dielectric material may be printed on or otherwise deposited on a portion of the base layer 818. The dielectric material may have a thickness that is between 0.25 to 1.5 of a quarter wave thickness. The thickness may be selected to produce various colors when light is reflected off of the dielectric material.

In some embodiments, one or more markings may convey information associated with the laminate, serve as aesthetic features, and/or provide security features. For example, the markings may indicate a source of the laminate 826, a type of precious metal (if present) in the laminate, a purity of precious metal (if present) in the laminate, an amount of precious metal (if present) in the laminate 826, a value of the laminate 826, a serial number of the laminate 826, and/or other information. In some embodiments, the markings may be applied by printing textual and/or image-based information on at least one of the substrates, intermediate base layers, base layers, adhesive layers, security layers, and/or other layers, holographically embossing at least one of the layers, and/or provided as separate layers. For example, in some embodiments, the second transparent substrate 820 may be printed with one or more text-based and/or image-based markings. The printing may be done by applying a substance such as ink to the second transparent substrate 820 and/or by indenting and/or embossing the markings onto the second transparent substrate 820. In some embodiments, the markings may be 3D printed onto the second transparent substrate 820. The markings may be applied prior to, during, and/or after the various layers are assembled. One or more of the markings may be of constant and/or variable thickness and/or may have different optical densities. In some embodiments, the security information may be provided between two opaque layers (such as the various base layers) so as to conceal sensitive information until the laminate 826 is delaminated, while some or all of the markings may be visible from an outside of the laminate 826 without delamination of the laminate 826.

In some embodiments, one or more openings or windows may be formed within one or both of the base layer 818 and the second base layer such that at least one of the one or more security features is visible via the opening. For example, one or more markings and/or other security features may be visible through the window without delaminating the laminate 826 as described above. The windows may be formed through one or more layers of material and may extend through all or only a portion of a thickness of the laminate 826.

The windows may be formed prior to, during, and/or after application of a given layer of material of the laminate. In some embodiments, the windows may be formed from removing material from an already-deposited layer. For example, portions of one or more already-applied layers may be feathered as described above, abraded, laser-etched, and/or otherwise removed to create a window. In some embodiments, a layer may be formed with a window prior to application to the laminate 826, such as by die-cutting a metallic leaf or otherwise forming a pre-shaped layer prior to applying the layer to the laminate 826. In some embodiments, a window may be formed by applying one or more layers in a manner in which a thin and/or blank area is formed, such as by using a masking agent (oil, ink, template of heat-resistant material, etc.) and/or selectively not applying any or a full thickness in one or more areas. In embodiments in which the window is only defined in interior layers (e.g., not defined by the second transparent substrate 820), the window may be formed prior to applying the second transparent substrate 820.

In some embodiments, such as those in which the markings convey information about the source, validity, or content of the laminate, a database may be maintained having the data associated with each laminate 826 produced. For example, each laminate may be prepared with one or more markings. An electronic record of the markings of each laminate may be produced. For example, an identifier of each laminate, such as a serial number, may be associated with one or more other pieces of data of the respective laminate. For example, each serial number may be associated with a source of the laminate, a type of precious metal in the laminate, a purity of precious metal in the laminate an amount of precious metal in the laminate, a value of the laminate, and/or other information associated with a laminate. This record may be stored such that the information provided on a given laminate can be compared to the stored record to verify the authenticity of the laminate. In a particular example, the markings may include a public encryption key, and the security information may include a private encryption key. The public key may be visible through a window in some embodiments. This may enable visual inspection of the public key ensures the public key matches the intended public key that was generated/assigned at time of inception of the private key. In some embodiments, the keys may be printed together. By printing the public key and private key together, it may be assured that the keys match up and eliminates the need to transmit the public key to another step of manufacture, thereby making the manufacturing process more secure. Additionally, by making the public key visible within the window and printing the public key and private key together on a single layer of the laminate, it can be readily verified that the printing step occurred by checking that the public key is present without the need to delaminate the laminate. In some embodiments, the private key may be printed in a wholly offline environment such that no data is saved on a network. The public key and any other associated security features may be viewed for verification, loading of bill, and/or checking of bill.

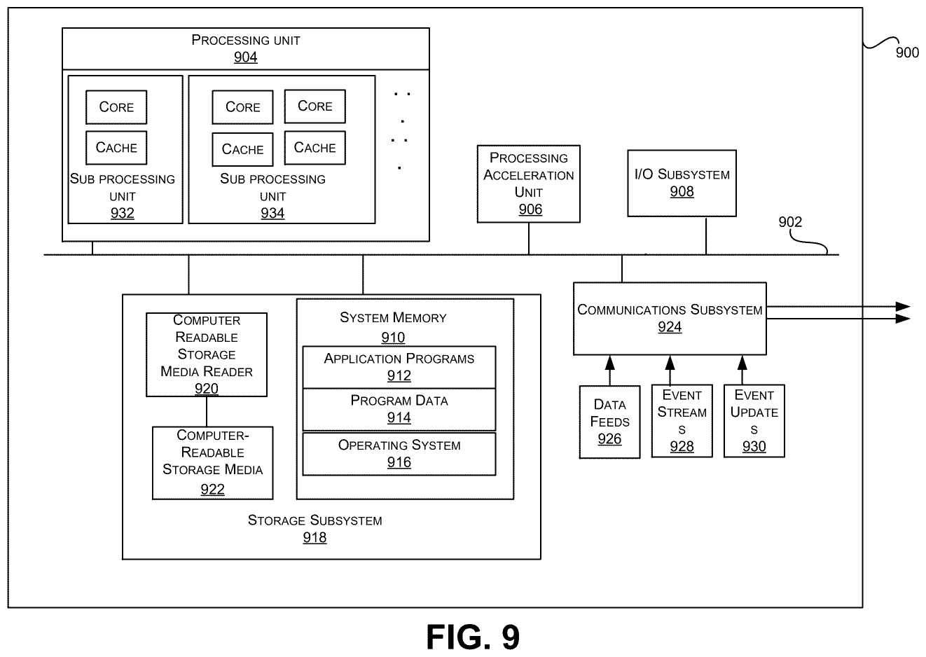

FIG. 9 illustrates an exemplary computer system 900, in which various embodiments may be implemented. The system 900 may be used to implement any of the methods described herein. For example, the system 900 may at least partially control an apparatus for creating laminates and related systems to perform the method 800 (e.g., via controller 802). As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices that enables users to control and interact with an input device through a natural user interface using gestures and spoken commands. Additionally, user interface input devices may include voice recognition sensing devices that enable users to interact with voice recognition systems through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader, 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that comprises software elements, shown as being currently located within a system memory 910. System memory 910 may store program instructions that are loadable and executable on processing unit 904, as well as data generated during the execution of these programs.

Depending on the configuration and type of computer system 900, system memory 910 may be volatile (such as random-access memory (RAM)) and/or non-volatile (such as read-only memory (ROM), flash memory, etc.). The RAM typically contains data and/or program modules that are immediately accessible to and/or presently being operated and executed by processing unit 904. In some implementations, system memory 910 may include multiple different types of memory, such as static random-access memory (SRAM) or dynamic random access memory (DRAM). In some implementations, a basic input/output system (BIOS), containing the basic routines that help to transfer information between elements within computer system 900, such as during start-up, may typically be stored in the ROM. By way of example, and not limitation, system memory 910 also illustrates application programs 912, which may include client applications, Web browsers, mid-tier applications, relational database management systems (RDBMS), etc., program data 914, and an operating system 916.

Storage subsystem 918 may also provide a tangible computer-readable storage medium for storing the basic programming and data constructs that provide the functionality of some embodiments. Software (programs, code modules, instructions) that when executed by a processor provide the functionality described above may be stored in storage subsystem 918. These software modules or instructions may be executed by processing unit 904. Storage subsystem 918 may also provide a repository for storing data used in accordance with some embodiments.

Storage subsystem 918 may also include a computer-readable storage media reader 920 that can further be connected to computer-readable storage media 922. Together and, optionally, in combination with system memory 910, computer-readable storage media 922 may comprehensively represent remote, local, fixed, and/or removable storage devices plus storage media for temporarily and/or more permanently containing, storing, transmitting, and retrieving computer-readable information.

Computer-readable storage media 922 containing code, or portions of code, can also include any appropriate media, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 900.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD or other optical media. Computer-readable storage media 922 may include, but is not limited to, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G, 5G, or EDGE (enhanced data rates for global evolution), WiFi (IEEE 802.4 family standards, or other mobile communication technologies, or any combination thereof), global positioning system (GPS) receiver components, and/or other components). In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services, web feeds such as Rich Site Summary (RSS) feeds, and/or real-time updates from one or more third party information sources.

Additionally, communications subsystem 924 may also be configured to receive data in the form of continuous and/or discontinuous data streams, which may include event streams 928 of real-time events and/or event updates 930, that may be continuous and/or discontinuous or unbounded in nature with no explicit end. Examples of applications that generate continuous and/or discontinuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, other ways and/or methods to implement the various embodiments should be apparent.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. It will be further appreciated that all testing methods described here may be based on the testing standards in use at the time of filing or those developed after filing.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or ±0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or ±0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A method of producing a laminate, comprising:
forming a sheet of laminates, comprising:
applying a base layer on a first transparent substrate comprising a first pattern, wherein at least a portion of the first pattern defines one or more borders of the laminate;
applying a second transparent substrate to the base layer, the second transparent substrate comprising a second pattern correlating to the first pattern;
identifying at least one feature from one or both one of the first pattern or the second pattern as a registration mark;
determining a position of a cutting apparatus relative to the sheet of laminates based at least in part on the registration mark; and
cutting the sheet of laminates according to the position of the cutting apparatus relative to the registration mark such that the one or more borders of the laminate are within a predetermined threshold.

2. The method of claim 1, wherein the predetermined threshold comprises 1 mm.

3. The method of claim 1, wherein the first pattern, the second pattern, and the registration mark comprise an edge protection pattern.

4. The method of claim 1, further comprising applying a second base layer to the first base layer.

5. The method of claim 4, wherein the first pattern and the second pattern form a repeating pattern that extends continuously from the laminate to an adjacent laminate.

6. The method of claim 1, wherein the first pattern and/or the second pattern are formed using ultraviolet sensitive ink.

7. The method of claim 1, further comprising:
forming an area between at least two of the first transparent substrate layer, the first base layer, the second base layer, or the second transparent substrate layer, the area characterized by weak adhesion between the layers; and
depositing a substance in the area.

8. The method of claim 7, wherein the substance comprises at least one of cobalt or ink.

9. A laminate, comprising:
a first transparent substrate layer comprising a first pattern at least partially defining borders on the first transparent substrate;
a base layer deposited on the first transparent substrate layer; and
a second transparent substrate formed on the base layer and comprising a second pattern, wherein the second pattern corresponds to the first pattern such that an edge protection pattern.

10. The laminate of claim 9, wherein the base layer comprises at least one of a metal or a ceramic.

11. The laminate of claim 9, wherein a registration mark is comprised on the borders on the first transparent substrate indicate a position of the laminate and used to cut the laminate according to the borders within a predetermined threshold.

12. The laminate of claim 11, wherein the predetermined threshold is 1 mm.

13. The laminate of claim 9, wherein at least one of the first pattern or the second pattern are formed using an oxidizing material.

14. The laminate of claim 9, wherein the base layer comprises a third pattern characterized by raised and/or lowered features.

15. The laminate of claim 9, wherein the first pattern and the second pattern combine to form a curved line along at least a portion of the borders on the first transparent substrate.

16. The laminate of claim 9, wherein a registration mark is comprised in the edge protection pattern.

17. The laminate of claim 9, wherein a registration mark is formed independently of the first pattern and the second pattern.

18. The laminate of claim 11, wherein the edge protection pattern comprises a continuous pattern on two or more laminates.

19. The laminate of claim 9, wherein the edge protection pattern reaches within 0.25 mm of an edge of at least one of the borders.

20. A sheet of laminates, comprising:
a first transparent substrate layer comprising a first pattern wherein at least a portion of the first pattern defines one or more borders of a plurality laminates;
a base layer disposed on the first transparent substrate layer; and
a second transparent substrate layer comprising a second pattern correlating to the first pattern, wherein the first pattern and the second pattern form an end protection pattern at least one of the one or more borders such that the each of the plurality of laminates comprises the edge protection pattern after cutting.

21. The sheet of laminates of claim 20, wherein a registration mark is formed outside of the edge protection pattern in an area independent of the laminate.

22. The sheet of laminates of claim 20, wherein a machine readable registration mark is generated at a predefined location on the sheet of laminates within a tolerance of 1 μm.

23. The sheet of laminates of claim 22, wherein the machine readable registration mark is used to align a cutting tool such that the laminate is cut from the sheet of laminates by the cutting tool within a tolerance of 1 mm.

24. The sheet of laminates of claim 20, further comprising a second base layer disposed on the base layer.

25. A non-transitory computer-readable medium comprising instructions that, when executed by one or more processors, cause the one or more processors to perform operations comprising:
forming a sheet of laminates, comprising:
applying a base layer on a first transparent substrate comprising a first pattern, wherein at least a portion of the first pattern defines one or more borders of the laminate;
applying a second transparent substrate to the base layer, the second transparent substrate comprising a second pattern correlating to the first pattern;
identifying at least one feature from one or both one of the first pattern or the second pattern as a registration mark;
determining a position of a cutting apparatus relative to the sheet of laminates based at least in part on the registration mark; and
cutting the sheet of laminates according to the position of the cutting apparatus relative to the registration mark such that the one or more borders of the laminate are within a predetermined threshold.
